(19) United States
(12) Patent Application Publication
(10) Pub. No.: US 2014/0360655 A1
(43) Pub. Date: Dec. 11, 2014

(54) OPTICAL-SHEET MANUFACTURING DEVICE AND OPTICAL-SHEET MANUFACTURING METHOD

(71) Applicant: Nippon Carbide Industries Co., Inc., Tokyo (JP)

(72) Inventors: Keiji Amemiya, Namerikawa-shi (JP); Ikuo Mimura, Uozu-shi (JP); Kiyohito Hiromitsu, Uozu-shi (JP); Kenichiro Naka, Uozu-shi (JP); Hiroshi Hamada, Uozu-shi (JP)

(21) Appl. No.: 14/369,387

(22) PCT Filed: Dec. 28, 2012
(86) PCT No.: PCT/JP2012/084093

§ 371 Date: Jun. 27, 2014

(30) Foreign Application Priority Data
Jan. 4, 2012 (JP) 2012-000300

(51) Int. Cl. B29D 11/00

(52) U.S. Cl. CPC B29D 11/0073
USPC 156/209; 156/500

(57) ABSTRACT

An optical-sheet manufacturing device 1 is provided with a first belt-shaped mold S1, a second belt-shaped mold S2, first and second supply units that supplies resins to the belt-shaped molds S1 and S2, respectively, and first and second embossing units that embosses the supplied resins on the first and second belt-shaped molds S1 and S2 to form first and second embossed sheets A′ and B′. The optical-sheet manufacturing device is characterized in that the first embossed sheet A′ embossed on the first belt-shaped mold S1 and the second embossed sheet B′ embossed on the second belt-shaped mold S2 are shifted by the rotation of the first belt-shaped mold S1 and the second belt-shaped mold S2 and the first embossed sheet A′ and the second embossed sheet B′ are sandwiched between the first belt-shaped mold S1 and the second belt-shaped mold S2 and are laminated.

### TECHNICAL FIELD

The present invention relates to an optical-sheet manufacturing device and an optical sheet manufacturing method.

### BACKGROUND ART

At the present time, an optical sheet that includes at least two optical layers and has a surface on which a collection of optical elements having three-dimensional shapes to act optically is formed or an optical sheet that is provided with an optical element having a flat surface is used. When a large number of optical elements are formed on the surface of the optical sheet, a cube corner type prism, a linear prism, a lenticular lens, a refraction type lens, a Fresnel lens, a linear Fresnel lens, a cross prism, an optical element for a hologram, or a planar optical element and the like is exemplified as the optical element.

In manufacturing of the optical sheet, precision of surface processing of the optical sheet such as shape precision of an optical element and flatness of a surface has a big influence on performance of the optical sheet. For this reason, different from general resin processing such as embossing processing, surface texturing, and satin finish processing performed on a surface of a normal resin processing product, processing having very high precision is necessary.

In Patent Document 1 to be described below, an example of a manufacturing device of an optical sheet having a surface provided with a collection of optical elements and a manufacturing method for the optical sheet is described.

In the manufacturing device of the optical sheet, parts of a first belt-shaped mold and a second belt-shaped mold having surfaces provided with molds for a large number of optical elements face each other and the individual belt-shaped molds rotate at the same speed. In addition, in a region where the first belt-shaped mold and the second belt-shaped mold are pressed to each other, resin sheets are sandwiched between the belt-shaped molds and the resin sheets are pressed to the individual belt-shaped molds. By the pressing, a resin is inserted into the molds for the optical elements formed on the surfaces of the individual belt-shaped molds and the large number of optical elements are formed on both surfaces of the resin sheets.

In addition, in FIG. 8 of Patent Document 1, a manufacturing device of an optical sheet formed by laminating a plurality of resin sheets and having both surfaces provided with a large number of optical elements is illustrated. In the manufacturing device of the optical sheet, two overlapped resin sheets ere supplied to a region where a part of a first belt-shaped mold and a part of a second belt-shaped mold are pressed to each other. The supplied two resin cheats are pressed by the first belt-shaped mold and the second belt-shaped mold and are laminated integrally by fusion splicing. At the same time, a plurality of optical elements are formed on a surface in the same way as the above case.

In this way, even when the optical sheet includes two layers, the optical sheet having both surfaces provided with the large number of optical elements is manufactured.

### CITATION LIST

### Patent Document

[Patent document 1] WO 2010/021133

### SUMMARY OF INVENTION

### Objects to be Achieved by the Invention

In the manufacturing device and the manufacturing method for the optical sheet described in Patent Document 1 mentioned above, when the optical sheet including at least two optical layers is manufactured, the large number of optical elements are formed on both surfaces at the same time as integrally laminating the plurality of resin sheets by the fusion splicing, as described above. In this case, the high pressure/heat should be applied from both the first belt-shaped mold and the second belt-shaped mold to the overlapped resin sheets. That is, it is necessary to give high energy to the resin sheets. For this reason, a shape of the surface of the manufactured optical sheet may be distorted and the optical elements formed on both surfaces may be deformed. In particular, when the optical sheet is manufactured at a high speed to improve productivity of the optical sheet, it is necessary to give the high energy to the resin cheats during a shorter period. For this reason, resin components may be gasified. When the gas remains, the surface of the manufactured optical sheet may be easily deformed and the optical elements may be easily deformed.

Accordingly, an object of the present invention is to provide an optical-sheet manufacturing device and an optical-sheet manufacturing method that make it possible to suppress surface deformation and improve productivity.

### Means For Achieving the Objects

To achieve the above object, according to one aspect of the present invention, there is provided an optical-sheet manufacturing device for manufacturing an optical sheet having at least two optical layers, including: a first belt-shaped mold and a second belt-shaped mold that rotate in a circumferential direction; a first supply unit that supplies a resin to the first belt-shaped mold; a first embossing unit that embosses the resin supplied to the first belt-shaped mold on the first belt-shaped mold to form a first embossed sheet becoming an optical layer of the side of one surface of the optical sheet; a second supply unit that supplies a resin to the second belt-shaped mold; a second embossing unit that embosses the resin supplied to the second belt-shaped mold on the second belt-shaped mold to form a second embossed sheet becoming an optical layer of the side of the other surface of the optical sheet; and a lamination unit that sandwiches the first embossed sheet and the second embossed sheet between the first belt-shaped mold and the second belt-shaped mold and laminates the first embossed sheet and the second embossed sheet, wherein the first embossed sheet embossed on the first belt-shaped mold and the second embossed sheet embossed on the second belt-shaped mold are moved to the lamination unit by rotation of the first belt-shaped mold and the second belt-shaped mold and are laminated.

According to another aspect of the present invention, there is provided an optical-sheet manufacturing method for manufacturing an optical sheet having at least two optical lagers. The optical-sheet manufacturing method includes a resin supply process for supplying a resin to each of a first belt-shaped mold rotating in a circumferential direction and a second belt-shaped mold rotating in the circumferential direction; an embossing process for embossing the resin supplied to the first belt-shaped mold on the first belt-shaped mold to form a first embossed sheet becoming an optical layer of the side of one surface of the optical sheet and embossing the resin supplied to the second belt-shaped mold on the second belt-shaped mold to form a second embossed sheet becoming an optical layer of the side of the other surface of the optical sheet; and a lamination process for sandwiching the first embossed sheet and the second embossed sheet between the first belt-shaped mold and the second belt-shaped mold and laminating the first embossed sheet and the second embossed sheet, after the first embossed sheet and the second embossed sheet are moved by the rotation of the first belt-shaped mold and the second belt-shaped mold.

According to the optical-sheet manufacturing device and the optical-sheet manufacturing method, the resins supplied to the first and second belt-shaped molds are embossed and the formed first and second embossed sheets on the first and second belt-shaped molds are moved. Then, the first embossed sheet and the second embossed sheet are sandwiched between the first belt-shaped mold and the second belt-shaped mold and are laminated. That is, in the optical-sheet manufacturing device according to the present invention, the first and second embossing units and the lamination unit are separated from each other and in the optical-sheet manufacturing method, the embossing process and the lamination process are performed in separated places. As such, after shapes of surfaces of the first and second embossed sheets are embossed, the first embossed sheet and the second embossed sheet are laminated. Therefore, supply of energy necessary for embossing the supplied resins and supply of energy necessary for laminating the embossed sheets can be dispersed. In addition, because the lamination is performed after the embossing is performed, an entire layer thickness of the resin at the time of performing the embossing can be decreased as compared with the case in which the embossing and the lamination are performed at the same time. For this reason, even when gas is generated in the resin at the time of performing the embossing, according to the present invention, the gas can be easily discharged as compared with the case in which the embossing and the lamination are performed as the same time. In this way, according to the present invention, deformation of a surface of a produced optical sheet can be suppressed as compared with the case in which the embossing and the lamination are performed at the same time.

In addition, even when the optical sheet is manufactured at a high speed to improve productivity, the deformation of the surface of each of the embossed sheets can be suppressed by dispersion of the energy applied to the first and second embossed sheets. Therefore, the productivity of the optical sheet can be improved.

In addition, because each of the embossed sheets is not separated from the belt-shaped mold from the embossing to the lamination, the shape of the surface of each of the embossed sheets that are embossed can be prevented from being distorted at the time of the lamination.

In the present invention, the embossing means shaping the resin to the surface of each of the belt-shaped molds and includes both the case in which an uneven mold is formed on the surface of each of the belt-shaped molds and the surface of each of the embossed sheets is shaped into an uneven shape and the case in which a flat mold is formed on the surface of each of the belt-shaped molds and the surface of each of the embossed sheets is shaped into a flat shape.

Preferably, the optical-sheet manufacturing device further includes an intermediate supply unit that supplies an intermediate optical sheet becoming an intermediate optical layer between the optical layer of the side of one surface and the optical layer of the side of the other surface in the optical sheet to at least one of the first embossed sheet and the second embossed sheet and the first embossed sheet and the second embossed sheet are laminated with the intermediate optical sheet therebetween, in the lamination unit. Preferably, the optical-sheet manufacturing method further includes an intermediate supply process for supplying an intermediate optical sheet becoming an intermediate optical layer between the optical layer of the side of one surface and the optical layer of the side of the other surface in the optical sheet to at least one of the first embossed sheet and the second embossed sheet and the first embossed sheet and the second embossed sheet are laminated with the intermediate optical sheet therebetween, in the lamination process.

As such, the intermediate optical sheet is supplied, so that the intermediate optical layer can be formed between the optical layer of the side of one surface and tire optical layer of the side of the other surface. In addition, after the intermediate optical sheet is laminated on at least one of the first embossed sheet and the second embossed sheet, the first embossed sheet and the second embossed sheet are laminated with the intermediate optical sheet therebetween, so that energy necessary for laminating the intermediate optical sheet and energy necessary for laminating the first embossed sheet and the second embossed sheet with the intermediate optical sheet therebetween can be dispersed and supplied. Therefore, when the intermediate optical sheet is supplied, the shape of the surface of the manufactured optical sheet can be suppressed from being distorted. As in the present invention, the embossing process and the lamination process are separated from each other, so that the intermediate optical layer can be laminated after the embossing, as described above. When the sheet is laminated, approximately uniform pressure tends to be applied to the entire sheet surface. However, when the embossing is performed, different pressures tend to be applied to portions in the sheet surface, according to the embossed shape in the sheet surface. For example, a nigh pressure tends to be applied no a portion in which the embossing is performed and the resin is thinly processed, as compared with a portion in which the resin is thickly processed. Therefore, when the embossing is performed on tire resin in a state in which the intermediate optical layer is laminated on the resin on the belt-shaped mold, different stress may be applied to in-plane portions of the intermediate optical layer. For this reason, when the intermediate optical layer is vulnerable to the stress, cracks may occur in the intermediate optical layer and deformation caused by the embossing stress may occur on the surface of the intermediate optical layer. However, as described above, by laminating the intermediate optical layer after the embossing, the cracks can be suppressed from occurring in the intermediate optical layer and the deformation caused by the embossing stress can be suppressed from occurring on the surface of the intermediate optical layer, when the intermediate optical layer is vulnerable to the stress.

Preferably, the intermediate optical sheet includes a fine particle layer in which fine particles having an average particle diameter of 5 nm to 300 nm are used as main components. In this case, the fine particles are preferably ceramic particles.

As such, when the intermediate optical sheet includes the fine particle layer, the fine particle layer may not have a binder to bind the ceramic particles and the ceramic particles adjacent to each other may contact each other or the fine particle layer may include the ceramic particles, a binding resin to bind surface portions of the ceramic particles, and voids formed between the ceramic particles. When the fine particle layer includes the binding resin, a glass transition point of the binding resin is preferably lower than a glass transition point of the resin configuring the first embossed sheet and a glass transition point of the resin configuring the second embossed sheet.

Preferably, the intermediate optical sheet includes a resin layer made of a resin and a glass transition point of the resin configuring the resin layer is lower than a glass transition point of the resin configuring the first embossed sheet and a glass transition point of the resin configuring the second embossed sheet. In this case, in the optical-sheet manufacturing device, viscosity of the resin configuring the resin layer in the lamination unit is preferably 150000 PaS or less. In the optical-sheet manufacturing method, viscosity of the resin in the lamination process is preferably 150000 PaS or less.

In the optical-sheet manufacturing device, temperatures of the first embossed sheet and the second embossed sheet in the lamination unit are preferably lower than a temperature of the resin embossed in the first embossing unit and a temperature of the resin embossed in the second embossing unit. In addition, in the optical-sheet manufacturing method, temperatures of the first embossed sheet and the second embossed sheet in the lamination process are preferably lower than temperatures of the resin on the first belt-shaped mold and the resin on the second bolt-shaped mold embossed in the embossing process.

The temperatures of the first embossed sheet and the second embossed sheet at the time of the lamination are lower than the temperatures of the first embossed sheet and the second embossed sheet at the time of the embossing, so that the deformation of the surfaces of the first embossed sheet and the second embossed sheet that are embossed can be further suppressed. Therefore, an optical sheet in which the deformation of the surface is further suppressed can be manufactured.

In the optical-sheet manufacturing device, preferably, the first belt-shaped mold is hung on a first heating roll and is heated on the first heating roll and the second belt-shaped mold is hung on a second heating roll and is heated on the second heating roll. Preferably, the resin supplied from the first supply unit to the first belt-shaped mold on the first heating roll is pressed by a heated first pressing roll in the first embossing unit, the resin supplied from the second supply unit to the second belt-shaped mold on the second heating roll is pressed by a heated second pressing roll in the second embossing unit, and the first embossed sheet on the first belt-shaped mold on the first heating roll and the second embossed sheet on the second belt-shaped mold on the second heating roll are pressed to each other in the lamination unit.

As such, the optical-sheet manufacturing device is configured, so that the first embossed sheet moves from the first embossing unit to the lamination unit in a state in which the first belt-shaped mold is hung on the first heating roll and the second embossed sheet moves from the second embossing unit to the lamination unit in a state in which the second bolt-shaped mold is hung on the second heating roll. For this reason, even when gas is generated in the resins supplied by the first embossing unit and the second embossing unit, each belt-shaped mold is continuously heated by each heating roll while each embossed sheet moves from each embossing unit to the lamination unit, so that the gas is discharged from the side of each embossed sheet opposite to each belt-shaped mold. Therefore, occurrence of the deformation of the surface of the optical sheet or the deformation of the optical element due to the remaining gas can be avoided.

In this case, preferably, a temperature of the first heating roll is lower than a temperature of the first pressing roll and a temperature of the second heating roll is lower than a temperature of the second pressing roll.

In the optical-sheet manufacturing device, pressures applied to the first embossed sheet and the second embossed sheet in the lamination unit are preferably lower than a pressure applied to the resin on the first belt-shaped mold in the first embossing unit and a pressure applied to the resin on the second belt-shaped mold in the second embossing unit. In the optical-sheet manufacturing method, pressures applied to the first embossed sheet and the second embossed sheet in the lamination process are preferably lower than a pressure applied to the resin on the first belt-shaped mold and a pressure applied to the resin on the second belt-shaped mold in the embossing process.

In the optical-sheet manufacturing device, the first embossing unit may function as the first supply unit and the second embossing unit may function as the second supply unit. In the optical-sheet manufacturing method, the supply process and the embossing process may be performed at the same time.

Preferably, the optical-sheet manufacturing device further includes a curing unit that cures the first embossed sheet and the second embossed sheet after the first embossed sheet and the second embossed sheet are laminated. Preferably, the optical-sheet manufacturing method further includes a curing process for curing the first embossed sheet and the second embossed sheet after the lamination process.

The resin of each of the embossed sheets is cured after the lamination, so that the embossed sheet is cured and shrank on the belt-shaped mold and the embossed sheet can re appropriately released from the belt-shaped mold.

### Effect of Invention

As described above, according to the present invention, an optical-sheet manufacturing device and an optical-sheet manufacturing method that make it possible to suppress surface deformation and improve productivity are provided.

### BRIEF DESCRIPTION OF DRAWINGS

FIG. 1 is a diagram illustrating an example of an optical sheet manufactured in a first embodiment.

FIG. 2 is an enlarged view of a first intermediate optical layer illustrating an example of the case in which the first intermediate optical layer is a functional layer.

FIG. 3 is an enlarged view of hollow particles.

FIG. 4 is an enlarged view of a first intermediate optical layer illustrating another example of the case in which the first intermediate optical layer is a functional layer.

FIG. 5 is a diagram illustrating a manufacturing device of the optical sheet illustrated in FIG. 1.

FIG. 6 is a flowchart illustrating a process of a manufacturing method for the optical sheet illustrated in FIG. 1.

FIG. 7 is a diagram illustrating a manufacturing device of an optical sheet according to a second embodiment of the present invention.

FIG. 8 is a diagram illustrating a manufacturing device of an optical sheet according to a third embodiment of the present invention.

### DESCRIPTION OF EMBODIMENTS

Hereinafter, preferred embodiments of an optical-sheet manufacturing device and an optical-sheet manufacturing method according to the present invention will be described in detail with reference to the drawings.

### First Embodiment

### [Optical Sheet]

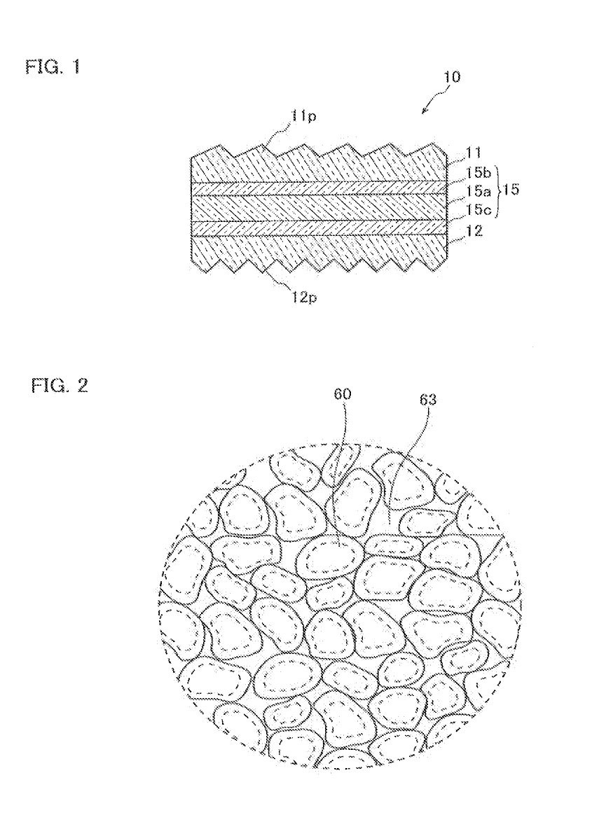

FIG. 1 is a diagram illustrating an example of an optical sheet manufactured in this embodiment.

As illustrated in FIG. 1, an optical sheet 10 according to this embodiment is an optical sheet that has at least two optical layers. The optical sheet 10 includes a first optical layer 11 that is an optical layer of the side of one surface, a second optical layer 12 that is an optical layer of the side of the other surface, and an intermediate optical layer 15 that is an optical layer between the first optical layer 11 and the second optical layer 12. The first optical layer 11, the intermediate optical layer 15, and the second optical layer 12 are laminated and integrated.

The first optical layer 11 and the second optical layer 12 are made of a resin with a light transmitting property. The first optical layer 11 and the second optical layer 12 have one surface on which a large number of optical elements 11p and 12p having three-dimensional shapes are formed by embossing and have the other surface formed to have a flat shape. The optical element lip that is formed in the first optical layer and the optical element 12p that is formed in the second optical layer 12 may have the same shapes or may have different shapes. FIG. 1 illustrates an example of the case in which the optical element 11p and the optical element 12p have the different shapes. Kinds of the optical elements 11p and 12p are not limited in particular. However, a prism to diffuse light, a prism to form a lenticular lens, a linear prism, a refraction type prism, a Fresnel lens, a linear Fresnel lens, a cross prism, and a prism for a hologram may be exemplified as the kinds. Although not illustrated, in the first optical layer 11 and the second optical layer 12, the surfaces of the sides on which the optical elements 11p and 12p are formed in FIG. 1 may be formed in a planar shape by the embossing.

The light transmitting property may mean light transmission, colorlessness and transparency, coloring, and a milky color or the like. In addition, in each of the first optical layer 11 and the second optical layer 12, when total light transmittance is measured using an A light source based on JIS K7105, the total light transmittance is preferably 30% or more and is more preferably 80% or more.

In addition, the first optical layer 11 and the second optical layer 12 may be made of resins of the same kinds or may be made of resins of different kinds. The resins to configure the first optical layer 11 and the second optical layer 12 are not limited in particular, as long as the resins have the light transmitting property. However, an acrylic resin, a polyester resin, a polycarbonate resin, a vinyl chloride resin, a polystyrene resin, a polyolefin resin, a fluorine resin, a cyclic olefin resin, a silicone resin, a polyurethane resin, or a combination thereof may be exemplified as the resins. Among them, the acrylic resin, the polycarbonate resin, the vinyl chloride resin, and the polyurethane resin are preferable, from the viewpoint of weather resistance or transparency and the like.

The intermediate optical layer 15 has a first intermediate optical layer 15a, a second intermediate optical layer 15b, and a third intermediate optical layer 15c. The second intermediate optical layer 15b is laminated on one surface of the first intermediate optical layer 15a and the third intermediate optical layer 15c is integrally laminated on the other surface of the first intermediate optical layer 15a.

The first intermediate optical layer 15a becomes, for example, a functional layer and has an optical property different from optical properties of the first optical layer 11 and the second optical layer 12. For example, when the first intermediate optical layer 15a has a refractive index lower than refractive indexes of the first optical layer 11 and the second optical layer 12, the first intermediate optical layer 15a becomes a functional layer functioning as a low refractive index layer. Or, when the first intermediate optical layer 15a has light diffusion higher than light diffusion of the first optical layer 11 and the second optical layer 12, the first intermediate optical layer 15a becomes a functional layer functioning as a light diffusion layer.

When the first intermediate optical layer 15a is the functional layer functioning as the low refractive index layer, the first intermediate optical layer 15a becomes a resin layer made of a resin with a low refractive index and a glass transition point of the resin layer is preferably lower than a glass transition point of a resin configuring the first optical layer 11 (a first embossed sheet A′ to be described below) and a glass transition point of a resin configuring the second optical layer 12 (a second embossed sheet B′ to be described below). In this case, as a material to configure the first intermediate optical layer, a fluorine resin or the like may be exemplified. In addition, when the first intermediate optical layer 15a is the functional layer functioning as the low refractive index layer or the light diffusion layer, a material obtained by dispersing fine particles having refractive indexes different from a refractive index of a resin in the resin or an agglomeration of fine particles and the like may be exemplified as a material to configure the first intermediate optical layer 15a. Specifically, a resin in which fine particles of ceramic particles such as hollow glass particles and hollow silica nanoparticles are dispersed, a resin in which bubbles are dispersed, or an agglomeration of fine particles of ceramic particles such as hollow glass particles and hollow silica nanoparticles may be exemplified. As described above, when the first intermediate optical layer 15a is made of the resin in which the ceramic particles such as the hollow glass particles and the hollow silica nanoparticles are dispersed or the agglomeration of the ceramic particles such as she hollow glass particles and the hollow silica nanoparticles, the fine particles account for the majority of the volume of the first intermediate optical layer 15a, so that the first intermediate optical layer 15a becomes a fine particle layer in which fine particles are main components. In the above description, the hollow ceramic particles are exemplified as the ceramic particles. However, the ceramic particles may not be hollow particles.

The second intermediate optical layer 15b and the third intermediate optical layer 15c are layers to support the first intermediate optical layer 15a. When the first intermediate optical layer 15a is the agglomeration of the hollow silica nanoparticles, the second intermediate optical layer 15b and the third intermediate optical layer 15c are layers to carry the hollow silica nanoparticles. Resins to configure the second intermediate optical layer 15b and the third intermediate optical layer 15c are not limited in particular, as long as the resins have a light transmitting property. However, an acrylic resin, a polyester resin, a polycarbonate resin, a vinyl chloride resin, a polystyrene resin, a polyolefin resin, a fluorine resin, a cyclic olefin resin, a silicone resin, a polyurethane resin and the like, or a combination thereof may be exemplified as the resins.

In addition, an embossed surface of the first optical layer 11 and an embossed surface of the second optical layer 12 face the sides opposite to each other, the second intermediate optical layer 15b is positioned at the side of the first optical layer 11, and the third intermediate optical layer 15c is positioned at the side of the second optical layer 12, so that the intermediate optical layer 15 is laminated integrally between the first optical layer 11

and the second optical layer 12. In this way, the optical sheet 10 becomes an optical sheet that is embossed surfaces provided at both sides and has a functional layer provided inside.

FIG. 2 is an enlarged view of the first intermediate optical layer 15 illustrating an example of the case in which the first intermediate optical layer 10 is a functional layer. As illustrated in FIG. 2, the intermediate optical layer 15 is made of a large number of hollow particles 60 and has a refractive index lower than refractive indexes of the first optical layer 11 and the second optical layer 12.

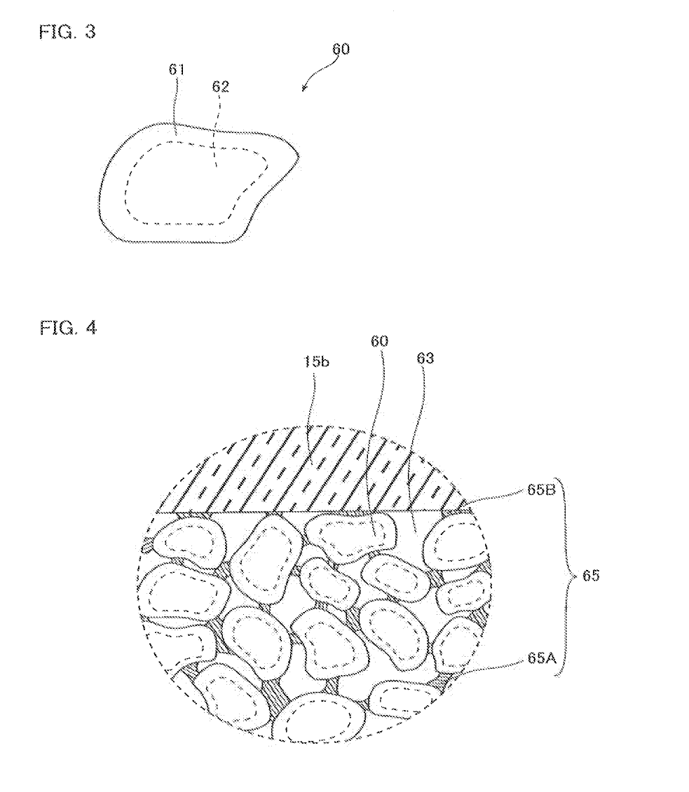

FIG. 3 is an enlarged view of the hollow particle 60. As illustrated in FIG. 3, the hollow particle 60 includes a shell 61 and a space 62 surrounded by the shell 61 is formed by the shell 61. The shell 61 is made of a material with a light transmitting property, similar to the first optical layer 11. As a material of the shell 61, the same resin as the first optical layer 11 or an inorganic material such as silica and glass may be exemplified, but the silica is preferable. As such, when the shell 61 is made of the silica or the glass, fine particles may be ceramic particles. As the hollow particle 60, EPOSTAR, SEAHOSTAR, and SOLIOSTAR (trade names) manufactured by NIPPON SHOKUBAI CO., LTD., OPTOBEADS (trade name) manufactured by NISSAN CHEMICAL INDUSTRIES, LTD., ART PEARL (trade name) manufactured by NEGAMI CHEMICAL INDUSTRIAL CO., LTD., DAIMICBEAZ (trade name) manufactured by DAINICHISEIKA COLOR & CHEMICALS MFG. CO., LTD., GANZ PEARL (trade name) manufactured by MAPION CO., LTD., TECHPOLYMER (trade name) manufactured by SEKISUI PLASTICS CO., LTD., and CHEMISNOW (trade name) manufactured by Soken Chemical & Engineering Co., Ltd. may be exemplified. In addition, as the hollow particle 60 of the hollow particle, an hollow particle obtained by coating an agglomeration of fine particles in which silica fine particles are agglomerated such that an inner portion becomes hollow with a silica layer is more preferable. As the hollow particle, SILINAX (registered trademark) manufactured by NITTETSU MINING CO., LTD. and SURURIA (registered trademark) manufactured by JGC CATALYSTS AND CHEMICALS LTD. may be exemplified. A shape of the hollow particle is not limited in particular, but may be a spherical shape or an indeterminate shape.

In addition, an average particle diameter of the hollow particle 60 is not limited in particular. However, the average particle diameter is preferably smaller than a wavelength of light entering on the optical sheet 10, that is, light propagated through the first optical layer 11. The average particle diameter of the hollow particle 60 is smaller than the wavelength of the light propagated through the first optical layer 11, so that diffused reflection of light in the first intermediate optical layer 15a can be suppressed and unintended light emission of entrance light can be suppressed. In addition, the average particle diameter of the hollow particle 60 is more preferably smaller than ½ of the wavelength of the light entering on the optical sheet 10 and is further preferably smaller than ¼. For example, when light of 420 nm to 800 nm as entered on the optical sheet 1, the average particle diameter of the hollow particle 60 is preferably 5 nm to 300 nm and is more preferably 30 to 120 nm. When the average particle diameter of the hollow particle 60 is measured, the average particle diameter may be measured by dynamic light scattering.

In addition, an average void ratio of the hollow particle 60 is preferably higher, from the viewpoint of decreasing a refractive index of the first intermediate optical layer 15a. However, the average void ratio is preferably 10% to 60%, from the viewpoint of securing the strength of the hollow particle 60.

As illustrated in FIG. 2, in the first intermediate optical layer 15a, the hollow particles 60 directly contact each other and are bound to each other. That is, in the first intermediate optical layer 15a, a binder to bind the hollow particles 60 is not filled between the hollow particles 60. It is thought than the blinding is generated by the cohesive force of the hollow particles 60. In particular, it is thought that the hollow particles are strongly bound when the hollow particles are made of silica and the average particle diameter is 30 nm to 120 nm. As such, because the binder to bind the hollow particles 60 is not filled between the hollow particles 60 and the hollow particles 60 directly contact each other and are bound to each other, voids 63 are formed between the hollow particles 60. In addition, a refractive index of the first intermediate optical layer 15a is decreased by a space 62 in the hollow particle 60 and the void 63 formed between the hollow particles 60.

The refractive index of the first intermediate optical layer 15a having the above configuration is preferably smaller than the refractive index of the first optical layer 11 and the refractive index of the second optical layer 12, for example, 1.17 to 1.37 and a specific refractive index of the first optical layer 11 and the second optical layer 12 and the first intermediate optical layer 15a is 0.69 to 0.92. The specific refractive index of the first optical layer 11 and the second optical layer 12 and the first intermediate optical layer 15a is the specific refractive index described above, so that light can be reflected between the first optical layer 11 and the first intermediate optical layer 15a. For example, when the first optical layer 11 and the second optical layer 12 are made of polycarbonate having a refractive index of 1.58 and the refractive index of the first intermediate optical layer 15a is 1.17 to 1.37, the specific refractive index of the first optical layer 11 and the second optical layer 12 and the first intermediate optical layer 15a becomes 0.766 to 0.867.

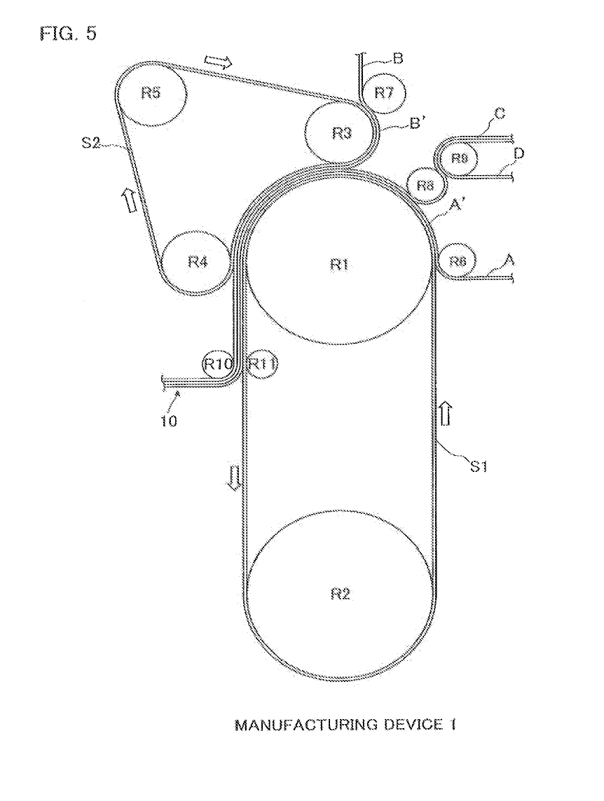

FIG. 4 is an enlarged view of the first intermediate optical layer 15a illustrating another example of the case in which the first intermediate optical layer 15a is a functional layer. That is, the first intermediate optical layer 15a illustrated in this example is different from the first intermediate optical layer 15a illustrated in FIG. 2 in that the first intermediate optical layer 15a is configured from the large number of hollow particles 60 illustrated in FIG. 3 and a binding resin 65, as illustrated in FIG. 4.

As illustrated in FIG. 4, the binding resin 65 includes a binding resin 65A to bind surface portions of the hollow particles 60 and a binding resin 65B to bind the second intermediate optical layer 15b and the third intermediate optical layer 15c and the surface portions of the hollow particles 60. A diagram illustrating an aspect where the third intermediate optical layer 15c and the hollow particles 60 are bound by the binding resin 65B is omitted because the diagram can be easily analogized from FIG. 4.

The voids 63 are formed between the hollow particles 60 by the binding resins 65A and 65B. From the viewpoint of increasing the volume of the voids 63, preferably, the surface portions of the hollow particles 60 approach each other, the second intermediate optical layer 15b and the surface portions of the hollow particles 60 approach each other, and the third intermediate optical layer 15c and the surface portions of the hollow particles 60 approach each other. In addition, preferably, the hollow particles 60 are in a non-contact state, the second intermediate optical layer 15b and the plurality of hollow particles 60 are in a non-contact state, and the third intermediate optical layer 15c and the plurality of hollow particles 60 are in a non-contact state.

In addition, a glass transition point of the binding resin 65 is preferably lower than a glass transition point of the resin configuring the first optical layer 11 (the first embossed sheet A′ to be described below) and a glass transition point of the resin configuring the second optical favor 12 (the second embossed sheet B′ to be described below). As a material of the binding resin 65, a material with a light transmitting property, for example, an acrylic resin, a urethane resin, an epoxy resin, a vinyl ether resin, a styrene resin, a silicone resin, or a silane coupling agent may be used. In particular, the acrylic resin, the vinyl ether resin, and the silane coupling agent are preferable because refractive indexes thereof are low. In addition, from the viewpoint of decreasing the refractive index, fluorine is preferably included in the material of the binding resin 65. For example, a fluorinated acrylic resin and a fluorinated vinyl ether resin may be used.

The silane coupling agent used for the binding resin 65 is not limited in particular. For example, a vinyl Group-containing silane coupling agent such as vinyltrimethoxy silane and vinyltriethoxy silane, an epoxy group-containing silane coupling agent such as glycidoxypropyitrimethoxy silane, a (meth)acrylic group-containing silane coupling agent such as methacryloyloxypropyltrimethoxy silane and acryloyloxypropyltrimethoxy silane, an isocyanate group-containing silane coupling agent such as isocyanatopropyltrimethoxy silane, a mercapto group-containing silane coupling agent such as mercaptopropyl trimethoxy silane, and an amino group-containing silane coupling agent such as aminopropyltriethoxysilane may be used. As the silane coupling agents, KBE series and KBM series (product names) manufactured by Shin-Etsu Chemicals Co., Ltd. may be exemplified.

In addition, a ratio (A):(B):(C) when the volume of the hollow particles 60 is set as (A), the volume of the voids 63 formed between the hollow particles 60 is set as (B), and the volume of the minding resin 65 is set as (C) is preferably 50 to 75; 10 to 49: 1 to 40, from the viewpoint of securing resistance of the low refractive index layer to the external force and decreasing the refractive index of the intermediate optical layer 15.

The total volume of the binding resin 65 between the hollow particles 60 is preferably small, from the viewpoint of increasing the volume of the voids 63 between the hollow particles 60. The ratio (A):(B):(C) is preferably 55 to 75: 15 to 44: 1 to 30 and is more preferably 60 to 75: 20 to 39: 1 to 20, from the viewpoint of securing resistance of the intermediate optical layer 15 to the external force and decreasing the refractive index of the intermediate optical layer 15.

The refractive index of the first intermediate optical layer 15a configured from the large number of hollow particles 60 and the binding resin 65 is lower than the refractive indexes of the first optical layer 11 and the second optical layer 12. For example, the refractive index of the intermediate optical layer 15 is 1.7 to 1.37 and the specific refractive index of the first optical layer 11 and the second optical layer 12 and the first intermediate optical layer 15a is 0.60 to 0.92. The specific refractive index of the first optical layer 11 and the second optical layer 12 and the first intermediate optical layer 15a is the specific refractive index described above, so that light can be appropriately reflected between the first optical layer 11 and the first intermediate optical layer 15a. For example, when the first optical layer 11 and the second optical layer 12 are made of polycarbonate having a refractive index of 1.58 and the refractive index of the first intermediate optical layer 15a is 1.17 to 1.37, the specific refractive index of the first optical layer 11 and the second optical layer 12 and the first intermediate optical layer 15a becomes 0.741 to 0.867.

### [Manufacturing Device]

Next, a manufacturing device to manufacture the optical sheer 10 illustrated in FIG. 1 will be described.

FIG. 5 is a diagram illustrating a manufacturing device 1 to manufacture the optical sheet 10 illustrated in FIG. 1. As illustrated in FIG. 5, the manufacturing device 1 includes a first rotation roll R1, a second rotation roll R2, a first belt-shaped mold S1 hung on the first rotation roll R1 and the second rotation roll R2, a pressing roll R6 supplying a first resin sheet A while pressing the first resin sheet A on the first belt-shaped mold, a pressing roll R8 supplying an intermediate resin sheet C while pressing the intermediate resin sheet C, a second belt-shaped mold S2 pressed to the first belt-shaped mold S1 in a part of a region where the first belt-shaped mold S1 is hung on the first rotation roll R1, a plurality of third to fifth rotation rolls R3, R4, and R5 on which the second belt-shaped mold S2 is hung, and a pressing roll R7 supplying a second resin sheet B while pressing the second resin sheet B on the second belt-shaped mold as a main configuration.

The first rotation roll R1 has an approximately columnar shape and is configured to be rotated around an axis of the first rotation roll. In addition, the first rotation roll R1 is configured such that a surface thereof is heated. The first rotation roll R1 may be used as a first heating roll. As a heating method, an internal heating method to heat the first rotation roll R1 from an Inner portion thereof or an external heating method to heat the first rotation roll R1 from an external portion thereof is exemplified. In the internal heating method, a heat generating means that generates heat by an induction heating system or a heat medium circulation system and is not illustrated is provided in the first rotation roll R1. In addition, in the external heating method, the first rotation roll R1 is heated from the external portion, in a region where the first belt-shaped mold S1 is not hung. At the time of heating from the external portion, an indirect heating means such as a hot air blowing device and an infrared lamp heating device may be used. When the first rotation roll R1 is heated by the internal heating method, the external heating method may be used together secondarily.

The second rotation roll R2 has an approximately columnar shape and is configured to be rotated around an axis of the second rotation roll R2. In addition, the second rotation roll R2 is configured to be rotated, such that a surface thereof has the same peripheral speed as a speed of the surface of the first rotation roll R1.

On the first rotation roll R1 and the second rotation roll R2, the first belt-shaped mold S1 is hung as described above. Therefore, the first belt-shaped mold S1 rotates around the first rotation roll R1 and the second rotation roll R2 in a predetermined traveling direction, according to rotation of the first rotation roll R1 and the second rotation roll R2.

In addition, in a region where the first belt-shaped mold S1 is hung on the first rotation roll R1, the first belt-shaped mold S1 is heated by the first rotation roll R1. At this time, a temperature of the surface of the first belt-shaped mold S1 becomes equal to or more than a flow start temperature of the first resin sheet A supplied to the first belt-shaped mold S1 as described below. The flow start temperature means a temperature at which the first resin sheet A flows to enable lamination or emboss forming after the first resin sheet A is heated at a temperature of a glass transition point or more and is softened.

On a surface of the outer circumferential side of the first belt-shaped mold S1, a large number of molds for the optical elements 11p formed in the first optical layer 11 of the optical sheet 10 are continuously formed. In a method to form a collection of the molds for the optical elements 11p on the surface of the outer circumferential side of the first belt-shaped mold S1, first, a mother mold to form the molds is formed. As a method to manufacture the mother mold, a method to cut grooves in a metal surface becoming the mother mold from a plurality of directions using a means such as a fly cut method, a ruling method, and a diamond turning method and form shapes of the optical elements is exemplified. The shapes of the optical elements of the mother mold formed as described above are transferred to the first belt-shaped mold S1. In this way, the molds for the optical elements 11p are formed on the surface of the first belt-shaped mold S1. As described above, in FIG. 1, when the surface of the side at which the optical element 11p of the first optical layer 11 is formed is formed in a planar shape, the surface of the outer circumferential side of the first belt-shaped mold S1 is formed in a flat shape. In this case, the surface of the outer circumferential side of the first belt-shaped mold S1 may be mirror polished.

The pressing roll R6 becomes a rotation roll that has a diameter smaller than a diameter of the first rotation roll R1. The pressing roll R6 may be used as a first pressing roll. In addition, the pressing roll R6 is separated from an outer circumferential surface of the first belt-shaped mold S1 by about an approximate thickness of the first optical layer 11 of the optical sheet 10 in a region where the first belt-shaped mold S1 is hung on the first rotation roll R1 and is heated and is arranged on an upstream side in a rotation direction of the first belt-shaped mold S1. Specifically, the pressing roll R6 is arranged to enable to supply the hung first resin sheet A to the first belt-shaped mold S1 with the first resin sheet A sandwiched between the first belt-shaped mold S1 and the pressing roll R6, when the first resin sheet A becoming the first optical layer 11 of the optical sheet 10 is hung. For this reason, the pressing roll R6 becomes a first supply unit that supplies a resin to the first belt-shaped mold S1. An outer circumferential surface of the pressing roll R6 is heated by the same method as a method for heating the outer circumferential surface of the first rotation roll R1 and a temperature thereof is higher than a temperature of the first rotation roll R1. In addition, the pressing roll R6 is arranged to press the first resin sheet A softened by heating of the first belt-shaped mold S1 by the first rotation roll R1 and heating by the pressing roll R6 to the first belt-shaped mold S1 to emboss the first resin sheet A and form the first resin sheet A as a first embossed sheet A′ on the first belt-shaped mold S1. For this reason, the pressing roll R6 also becomes a first embossing unit that embosses the resin supplied to the first belt-shaped mold S1. That is, in this embodiment, the pressing roll R6 functions as the first supply unit and the first embossing unit.

The pressing roll R8 has approximately the same configuration as the pressing roll R6, except that the pressing roll R8 is not heated as much as the pressing roll R6 is done. In addition, the pressing roll R8 is arranged to be separated from the outer circumferential surface of one first belt-shaped mold S1 by approximate the thickness of the first optical layer 11 and the intermediate optical layer 15 of the optical sheet 10, at a position shifted to a traveling direction side of the first belt-shaped mold S1 from a position at which the pressing roll R6 is arranged, in a region where the first belt-shaped mold S1 is hung on the first rotation roll R1. Specifically, the pressing roll R8 is arranged to enable to supply a hung intermediate optical sheet C to the first embossed sheet A′ with the intermediate optical sheet C sandwiched between the first embossed sheet A′ embossed on the first belt-shaped mold S1 and the pressing roll R8, when the intermediate optical sheet C becoming the intermediate optical layer 15 of the optical sheet 10 is hung. Therefore, the pressing roll R8 becomes an intermediate supply unit that supplies the intermediate optical sheet C to the first embossed sheet A′.

In addition, a process roll R9 is arranged at a position separated from the pressing roll R8, at the side of the pressing roll R8 opposite to the side of the first belt-shaped mold S1. The process roll R9 is configured to release a process sheet D with the sheets sandwiched between the pressing roll R8 and the process roll R9, when the sheets are supplied in a state in which the process sheet D is stuck on the intermediate optical sheet C.

The third and fourth rotation rolls R3 and R4 are arranged to be separated from the first belt-shaped mold S1 in the region where the first belt-shaped mold S1 is hung on the rotation roll R1, the third rotation roll R3 is arranged at a position shifted to the traveling direction side of the first belt-shaped mold S1 from the position of the pressing roll R8, and the fourth rotation roll R4 is arranged at a position shifted to the traveling direction side of the first belt-shaped mold S1 from the position of the third rotation roll R3. In addition, the fifth rotation roll R5 is arranged at a position remote from the first belt-shaped mold S1. In this way, the third to fifth rotation rolls R3, R4, and R5 are arranged to draw a triangle.

As described above, the second belt-shaped mold S2 is hung on the third to fifth rotation rolls R3, R4, and R5. In addition, the second belt-shaped mold S2 rotates around the third to fifth rotation rolls R3, R4, and R5 to move according to movement of the first belt-shaped mold S1, between the third rotation roll R3 and the fourth rotation roll R4. The rotation rolls R3, R4, and R5 are configured such that positions thereof can be adjusted by a hydraulic cylinder not illustrated. The force is applied to the fifth rotation roll R5 to pull the second belt-shaped mold S1 and the tensile force is given to the second belt-shaped mold S2.

In addition, an outer circumferential surface of the third rotation roll R3 that is arranged in a place where the second belt-shaped mold S2 and the first belt-shaped mold S1 approach each other is heated by the same method as the method for heating the outer circumferential surface of the first rotation roll R1. Therefore, a surface of the second belt-shaped mold S2 is heated in a region where the second belt-shaped mold S2 is hung on the third rotation roll R3. A temperature of the surface of the third rotation roll R3 becomes a temperature higher than the temperature of the first rotation roll R1 and becomes equal to or more than a flow start temperature of the second resin sheet B supplied to the second belt-shaped mold S2 as described below. That is, the temperature of the surface of the second belt-shaped mold S2 is in a range of temperatures equal to or more than a temperature at which the second resin sheet B flows to enable emboss forming after the second resin sheet B is heated at the temperature equal to or more than the glass transition point and is softened, and temperatures at which the second resin sheet B is not resolved. The third rotation roll R3 may be used as a second heating roll.

As such, the second belt-shaped mold S2 rotates along the heated first belt-shaped mold S1 while a part thereof is heated. For this reason, when the resin sheets are arranged on the first belt-shaped mold S1 and the second belt-shaped mold S2, respectively, the resin sheets receive heat from the first belt-shaped mold S1 and the second belt-shaped mold S2, are sandwiched between the first belt-shaped mold S1 and the second belt-shaped mold S2, and are laminated. That is, a lamination unit is configured by a part of one region where the first belt-shaped mold S1 is hung on the first rotation roll R1 and at least a part of the region where the second belt-shaped mold S2 rotates along the first belt-shaped mold S1.

In addition, the fourth rotation roll R4 that is arranged in a place where the second belt-shaped mold S2 loses touch with the first belt-shaped mold S1 is configured such that a surface thereof is cooled. As a cooling method, an internal cooling method to cool the fourth rotation roll R4 from an inner portion thereof is exemplified. As a cooling means that cools the inner portion of the fourth rotation roll R4, a circulation type cooling means that makes a cooling medium such as water or cooling oil circulate through the fourth rotation roll R4 and cooling the fourth rotation roll is exemplified. Therefore, at least a part of the resin that is softened by heat from the first rotation roll R1 or the third rotation roll R3, is sandwiched between the first belt-shaped mold S1 and the second belt-shaped mold S2, and moves is cooled by the fourth rotation roll R4 and is cured. Therefore, the fourth rotation roll R4 and the part of the region of the second belt-shaped mold S2 hung on the fourth rotation roll R4 become a curing unit.

On the surface of the outer circumferential side of the second belt-shaped mold S2 hung on the third to fifth rotation rolls R3, R4, and P5, a large number of molds for the optical elements 12p formed in the second optical layer 12 of the optical sheet 10 are continuously formed. A method for forming a collection of the molds for the optical elements 12p on one surface of the second belt-shaped mold S2 may be the same as the method for forming the molds on the surface of the outer circumferential side of the first belt-shaped mold. As described above, in FIG. 1, when the surface of the side at which the optical element 12p of the second optical layer 12 is formed is formed in a planar shape, the surface of the outer circumferential side of the second belt-shaped mold S2 is formed in a flat shape. In this case, the surface of the outer circumferential side of the second belt-shaped mold S2 may be formed in a flat shape, similar to the case in which the surface of the outer circumferential side of the first belt-shaped mold S1 is formed in a flat shape.

The pressing roll R7 has approximately the same configuration as the pressing roll R6 and is heated at a temperature higher than a temperature of the rotation roll R3. The pressing roll R7 may be used as a second pressing roll. In addition, the pressing roll R7 is arranged to be separated from the outer circumferential surface of the second belt-shaped mold S2 by approximate the thickness of the second optical layer 12 of the optical sheet 10, in the region where the second belt-shaped mold S2 is hung on the third rotation roll R3 and is heated. Specifically, the pressing roll R7 is arranged to enable to supply the hung second resin sheet B to the second belt-shaped mold S2 with the second resin sheet B sandwiched between the second belt-shaped mold S2 and the pressing roll R7, when the second resin sheet B becoming the second optical layer 12 of the optical sheet 10 is hung. For this reason, the pressing roll R7 becomes a second supply unit that supplies a resin to the second belt-shaped mold S2. In addition, the pressing roll R7 is arranged to press the second resin sheet B softened by heating of the second belt-shaped mold S2 by the third rotation roll R3 and heating by the pressing roll R7 to the second belt-shaped mold S2 to emboss the second resin sheet B and form the second resin sheet B as a second embossed sheet B′ on the second belt-shaped mold S2. For this reason, the pressing roll R7 also becomes a second embossing unit that embosses the resin supplied to the second belt-shaped mold S2. That is, in this embodiment, the pressing roll R7 functions as the second supply unit and the second embossing unit.

In addition, a set of releasing rolls R10 and R11 functioning as a releasing unit is arranged to sandwich the first belt-shaped mold S1 between them, in a place moved to the traveling direction of the first belt-shaped mold S1 from a place where the second belt-shaped mold S2 loses touch with the first belt-shaped mold S1. Specifically, the releasing roll R10 is arranged to be separated from the outer circumferential surface of the first belt-shaped mold S1 by the thickness of the optical sheet 10 and the releasing roll R11 is arranged to contact an inner circumferential surface of the first belt-shaped mold S1.

### [Manufacturing Method]

Next, a manufacturing method for the optical sheet by the manufacturing device 1 of the optical sheet will be described.

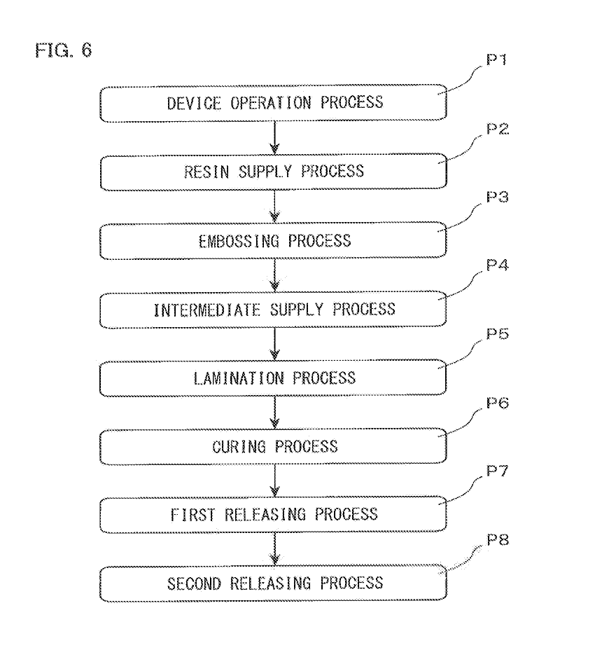

FIG. 6 is a flowchart illustrating a manufacturing method for the optical sheet illustrated in FIG. 1. As illustrated in FIG. 6, the manufacturing method for the optical sheet in this embodiment includes a device operation process P1, a resin supply process P2, an embossing process P3, an intermediate supply process P4, a lamination process P5, a curing process P6, a first releasing process P7, and a second releasing process P8 as main processes.

### <Device Operation Process P1>

First, the first and second rotation rolls R1 and R2 illustrated in FIG. 5 are rotated. By the rotation of the first and second rotation rolls R1 and R2, the first belt-shaped mold S1 rotates around the first rotation roll R1 and the second rotation roll R2. Because a rotation speed of the first belt-shaped mold S1 is appropriately adjusted according to the thickness of each optical layer forming the optical sheet 10 to be manufactured or the kind of the resin, the rotation speed is not limited in particular. However, the rotation speed is preferably 1 to 30 m/min and is more preferably 2 to 20 m/min.

At this time, the surface of the first rotation roll R1 is heated by the heating method described above. In this way, the surface of the first rotation roll R1 is heated, so that the region of the first belt-shaped mold S1 hung on the first rotation roll R1 is heated.

In addition, the third to fifth rotation rolls are rotated to rotate the second belt-shaped mold S2. At this time, the second belt-shaped mold S3 rotates according to the rotation of the first belt-shaped mold S1, between the third rotation roll R3 and the fourth rotation roll R4 .

In addition, the surface of the third rotation roll R3 is heated by the heating method described above. In this way, the surface of the third rotation roll R3 is heated, so that the region of the second belt-shaped mold S2 hung on the third rotation roll R3 is heated. The fourth rotation roll R4 that is provided in the place where the second belt-shaped mold S2 loses touch with the first belt-shaped mold S1 is cooled. Therefore, the region of the second belt-shaped mold S2 that is hung on the fourth rotation roll R4 is cooled.

As such, the second belt-shaped mold S2 approaches the first belt-shaped mold S1 in a heated state, moves along the first belt-shaped mold S1, and loses touch with one first belt-shaped mold S1 in a cooled state.

In addition, the pressing roll R6 is heated at a temperature higher than a temperature of the first rotation roll R1 and the pressing roll R7 is heated at a temperature higher than a temperature of the second rotation roll R3.

### [Resin Supply Process P2]

When the first bolt-shaped mold S1 and the second beet-shaped mold S2 are rotated by the device operation process P1, the first resin sheet A fed from a reel not illustrated and hung on the heated pressing roll R6 is sandwiched between the pressing roll R6 and the first belt-shaped mold S1 and is supplied to the first belt-shaped mold S1. In this embodiment, as described above, the pressing roll R6 is arranged in close proximity to the first belt-shaped mold S1, in the region where the first belt-shaped mold S1 is heated. For this reason, the first resin sheet A is supplied directly to the heated region of the first belt-shaped mold S1. At this time, because the first resin sheet A is pressed by the pressing roll R6 and is supplied to the first belt-shaped mold S1, occurrence of wrinkles or mixing of bubbles in the first resin sheet A is suppressed.

In addition, the second resin sheet B fed from a reel not illustrated and hung on the heated pressing roll P7 is sandwiched between the pressing roll R7 and the second belt-shaped medal S2 and is supplied to the second belt-shaped mold S2. In this embodiment, as described above, the pressing roll R7 is arranged in close proximity to the second belt-shaped mold S2, in the region where the second belt-shaped mold S2 is heated. For this reason, the second resin sheet B is supplied directly to the heated region of the second belt-shaped mold S2. At this time, because the second resin sheet B is pressed by the pressing roll R7 and is supplied to the second belt-shaped mold S2, occurrence of wrinkles or mixing of bubbles in the second resin sheet B is suppressed.

In this way, the resin is supplied to each of the first belt-shaped mold S1 rotating in a circumferential direction and the second belt-shaped mold S2 rotating in the circumferential direction.

### <Embossing Process P3>

The first resin sheet A that is heated by the pressing roll R6 and is supplied to the first belt-shaped mold S1 is also heated by the heat of the first belt-shaped mold S1 immediately after being supplied, is heated at the temperature equal to or more than the flow start temperature of the first resin sheet A, and is softened. In addition, the softened first resin sheet A is embossed on the first belt-shaped mold S1 by the pressing force from she pressing roll R6. The pressing force of the pressing roll R6 depends on such as the kind or the viscosity of the resin configuring the first resin sheet A or the shape of the first belt-shaped mold S1 and is appropriately set. In this way, the first resin sheet A embossed on the first belt-shaped mold S1 is moved as the first embossed sheet A′ by the rotation of the first belt-shaped mold S1.

In addition, the second resin sheet B that is heated by the pressing roll R7 and is supplied to the second belt-shaped mold S2 is also heated by the heat of the second belt-shaped mold S2 immediately after being supplied, is heated at the temperature equal to or more than the flow start temperature of the second resin sheet B, and is softened. The viscosity of the softened second resin sheet B is the same as the viscosity of the first resin sheet A softened on the first belt-shaped mold S1. In addition, the softened second resin sheet B is embossed on the second bait-shaped mold S2 by the pressing force from the pressing roll R7. The pressing force of the pressing roll R2 depends on such as the kind of the resin configuring the second resin sheet B or the shape of the second belt-shaped mold S2 and is not limited in particular. However, the pressing force of the pressing roll R2 is the same as the pressing force of the pressing roll R6. In this way, the second resin sheet B embossed on the second belt-shaped mold S2 is moved as the second embossed sheet B′ by the rotation of the second belt-shaped mold S2.

In this embodiment, the first resin sheet A is supplied to the first belt-shaped mold S1 and is embossed and the second resin sheet B is supplied to the second belt-shaped mold S2 and is embossed. That is, in this embodiment, the resin supply process P2 and the embossing process P3 are performed at the same time.

### <Intermediate Supply Process P4>

The intermediate optical sheet C in this embodiment is a sheet that becomes the intermediate optical layer 15 of the optical sheet 10 illustrated in FIG. 1. Specifically, the intermediate optical sheet C is a sheet in which the second intermediate optical layer 15b and the third intermediate optical layer 15c functioning as carrying layers made of hollow silica nanoparticles are integrally laminated on both surfaces of the first intermediate optical layer 15a functioning as the functional layer made of the agglomeration of the hollow silica nanoparticles. The intermediate optical sheet C is wound around a reel not illustrated, in a state in which the process sheet D is stuck on the second intermediate optical layer 15b. In addition, from the reel, the intermediate optical sheet C and the process sheet D are hung on the process roll R9 and are fed. In addition, only the intermediate optical sheet C in the supplied intermediate optical sheet C and process sheet D is hung on the pressing roll R8 and the process sheet D is released from the intermediate optical sheet and is collected from the process roll R9. At this time, the intermediate optical sheet C is hung on the pressing roll R8 in a state in which the surface of the side of the third intermediate optical layer 15c faces the side of the pressing roll R8. The intermediate optical sheet C hung on the pressing roll R8 is sandwiched between the pressing roll R8 and the first embossed sheet A′ moving together with the first belt-shaped mold S1 and is supplied to the first embossed sheet A′. At this time, because the second intermediate optical layer 15b functioning as an adhesive layer faces the side of the first embossed sheet A′, the intermediate optical sheet C is stuck on the first embossed sheet A′ and a deviation on the first embossed sheet A′ is prevented. In addition, the first embossed sheet A′ on the first belt-shaped mold S1 and the intermediate optical sheet C on the first embossed sheet are further moved by the rotation of the first belt-shaped mold S1.

### <Lamination Process P5>

A laminated body of the moved first embossed, sheet A′ and intermediate optical sheet C and the second embossed sheet B′ approach each other as the first belt-shaped mold S1 and the second belt-shaped mold S2 approach each other. Then, the laminated body and the second embossed sheet B′ are sandwiched between the first belt-shaped mold S1 and the second belt-shaped mold S2 and are crimped to each other. In addition, the intermediate optical layer C and the second embossed sheet B′ are laminated by the heat from the first belt-shaped mold S1 and the second belt-shaped mold S2. In this way, the first embossed sheet A′ and the second embossed sheet B′ are laminated integrally with the intermediate optical sheet C therebetween. At this time, pressure applied to the first embossed sheet A′ and the second embossed sheet B′ are preferably lower than a pressure applied to the resin on the first belt-shaped mold S1 in the first embossing unit and a pressure applied to the resin on the second belt-shaped mold S2 in the second embossing unit. Because the temperature of the first rotation roll R1 functioning as the first heating roll is lower than the temperature of the pressing roll R6 functioning as the first pressing roll and the temperature of the third rotation roll R3 functioning as the second heating roll is lower than the temperature of the pressing roll R7 functioning as the second pressing roll, at this time, the temperatures of the first embossed sheet A′ and the second embossed sheet B′ become lower than the temperature of the resin at the time of being embossed. However, at least the first embossed sheet A′ and the second embossed sheet B′ are maintained in a softened state without being cured. In addition, the viscosity of the resin configuring the intermediate optical sheet in the lamination process is preferably 150000 PaS or less.

### <Curing Process P6>

The first embossed sheet A′, the intermediate optical sheet C, and the second embossed sheet B′ that are sandwiched between the first belt-shaped mold S1 and the second belt-shaped mold S2 and are laminated are further moved by the rotation of the first belt-shaped mold S1 and the second belt-shaped mold S2. In addition, in the region of the second belt-shaped mold S2 between the third rotation roll R3 and the fourth rotation roll R4, the temperature of the second belt-shaped mold S2 begins to decrease, the temperature of the side of the second embossed sheet B′ begins to decrease gradually according to the decrease in the temperature of the second belt-shaped mold S2, and the laminated first embossed sheet A′, intermediate optical sheet C, and second embossed sheet B′ begin to be cured from the side of the second embossed sheet B′. In addition, when the laminated first embossed sheet A′, intermediate optical sheet C, and second embossed sheet B′ move and come close to the place where the first belt-shaped mold S1 and the second belt-shaped mold S2 lose touch with each other, as described above, the region of the second belt-shaped mold S2 hung on the fourth rotation roll R4 is cooled by the fourth rotation roll R4. For this reason, the laminated first embossed sheet A′, intermediate optical sheet C, and second embossed sheet B′ are cooled from the side of the second embossed sheet B′ and are further cured.

### <First Releasing Process P7>

In addition, the second belt-shaped mold S2 changes a direction to be wound around the pressing roll R5 and loses touch with the first belt-shaped mold S1. At this time, the laminated first embossed sheet A′, intermediate optical sheet C, and second embossed sheet B′ closely adhere to the surface of the first belt-shaped mold S1 and are released from the second belt-shaped mold S2. At this time, at least the surface side of the second embossed sheet B′ is cured by the fourth rotation roll R4 functioning as the curing unit. Therefore, the second embossed sheet B′ is appropriately released from the second belt-shaped mold S2. In addition, when the movement is further made, the first belt-shaped mold S1 is separated from the rotation roll R1 and accordingly, the temperature of the first belt-shaped mold S1 decreases. When the temperature of the first belt-shaped mold S1 decreases, the laminated first embossed sheet A′, intermediate optical sheet C, and second embossed sheet B′ are cooled from the side of the first embossed sheet A′ and are further cured from the side of the first embossed sheet A′. As such, the curing process P6 is continuously performed before and after the first releasing process P7, after the lamination process P5. As described above, the fourth rotation roll is need as the curing unit. However, the second belt-shaped mold S2 between the third rotation roll R3 and the fourth rotation roll R4 or the first belt-shaped mold S1 after losing touch with the first rotation roll R1 may be assumed as the curing unit.

### <Second Releasing Process P8>

Next, the laminated first embossed sheet A′, intermediate optical sheet C, and second embossed sheet B′ that move according to the rotation of the first belt-shaped mold S1 are sandwiched between the releasing roll R10 and the releasing roll R11 with the belt-shaped mold S1 therebetween. In addition, the laminated first embossed sheet A′, intermediate optical sheet C, and second embossed sheet B′ change a direction to be wound around the releasing roll R10 and are released from the first belt-shaped mold S1. At this time, at least the surface side of the first embossed sheet A′ is cured by the first belt-shaped mold S1 after losing touch with the first rotation roll R1, functioning as the curing unit. Therefore, the first embossed sheet A′ is appropriately released from the first belt-shaped mold S1. In this way, the optical sheet 10 in which the first embossed sheet A becomes the first optical layer 11, the second embossed sheet B becomes the second optical layer 12, and the intermediate optical sheet C becomes the intermediate optical layer 15 is obtained. In addition, the optical sheet 10 is wound around a reel not illustrated.

As described above, according to the manufacturing device 1 and the manufacturing method for the optical sheet 10 according to this embodiment, after each of the first resin sheet A supplied to the first belt-shaped mold S1 and the second resin sheet B supplied to the second belt-shaped mold is embossed and the intermediate optical sheet C is supplied to the first embossed sheet A′, the first embossed sheet A′, the intermediate optical sheet C, and the second embossed sheet B′ are sandwiched between the first belt-shaped mold S1 and the second belt-shaped mold S2 and are laminated. As such, after the shapes of the surfaces of the first and second embossed sheets A′ and B′ are embossed, the first embossed sheet A′, the intermediate optical sheet C, and the second embossed sheet B′ are laminated. Therefore, supply of energy necessary for embossing the embossed sheets A′ and B′ and supply of energy necessary for laminating the first embossed sheet A′, the intermediate optical sheet C, and the second embossed sheet B′ can be dispersed. In addition, because the lamination process is performed after the embossing process is performed, an entire layer thickness of the resin at the time of performing the embossing can be decreased as compared with the case in which the embossing and the lamination are performed at the same time. For this reason, even when gas is generated in the resin at the time of performing the embossing, according to the manufacturing device and the manufacturing method for the optical sheet according to this embodiment, the gas can be easily discharged as compared with the case in which the embossing and the lamination are performed at the same time. Therefore, deformation of the surface of the produced optical sheet 10 can be suppressed as compared with the case in which the embossing of each of the embossed sheets A′ and B′ and the lamination of each of the embossed sheets A′ and B′ are performed at the same time.

In addition, even when the optical sheet 10 is manufactured at a high speed to improve productivity, the deformation of the surface of each of the first and second embossed, sheets A′ and B′ can be suppressed by dispersion of the energy applied to the first and second embossed sheets A′ and B′. Therefore, the productivity of the optical sheet 10 can be improved.

In addition, because each of the embossed sheets A′ and B′ is not separated from each of the belt-shaped molds S1 and S2 from the embossing to the lamination, the shape of the surface of each of the embossed sheets that are embossed can be prevented from being distorted at the time of the lamination.

In this embodiment, the pressing rolls R6, R7, and R8 may be heated or may not be heated. However, the pressing rolls R6, R7, and R8 are preferably heated at the temperature lower than the temperature of the first rotation roll R1 or the third rotation roll R3. In addition, the releasing rolls R10 and R11 are preferably cooled, from the viewpoint of more appropriately releasing the optical sheet 10 from the first belt-shaped mold S1.

In addition, in this embodiment, the pressing roll R6 is configured to function as the first supply unit and the first embossing unit. However, the first supply unit and the first embossing unit may be separately provided. In this case, a supply roll having the same configuration as the pressing roll R6 may be newly arranged in close proximity to the first belt-shaped mold S1, in the region where the first belt-shaped mold S1 is hung on the second rotation roll R2, and the first resin sheet A may be sandwiched between the newly arranged supply roll and the first belt-shaped mold S1 and may be supplied to the first belt-shaped mold S1. In this case, the newly arranged supply roll becomes the first supply unit. In addition, the first resin sheet A is moved to the pressing roll R6 by the rotation of the first belt-shaped mold S1, is pressed to the first belt-shaped mold S1 by the pressing roll R6, and is embossed. In this case, the pressing roll R6 becomes the first embossing unit.

Likewise, in this embodiment, the pressing roll R7 is configured to function as the second supply unit and the second embossing unit. However, second supply unit and the second embossing unit may be separately provided. In this case, a supply roll having the same configuration as the pressing roll R7 may be newly arranged in close proximity to the second belt-shaped mold S2, in the region where the second belt-shaped mold S2 is hung on the fifth rotation roll R5, and the second resin sheet B may be sandwiched between the newly arranged supply roll and the second belt-shaped mold S2 and may be supplied to the second belt-shaped mold S2. In this case, the newly arranged supply roll becomes the second supply unit. In addition, the second resin sheet B is moved to the pressing roll R7 by the rotation of the second bolt-shaped mold S2, is pressed to the second belt-shaped mold S2 by the pressing roll R7, and is embossed. In this case, the pressing roll R7 becomes the second embossing unit.

In addition, in the embodiment described above, a cooling unit that cools the first embossed sheet A′, the intermediate optical sheet C, and the second embossed sheet B′ laminated on the first belt-shaped mold S1 may be provided from the first rotation roll R1 to the releasing rolls R11 and R10. In this case, because the cooling unit cures at least the first embossed sheet A′, the cooling unit becomes the curing unit. By providing the curing unit, the first embossed sheet A′ can be more appropriately released from the first belt-shaped mold S1.

In addition, the first rotation roll R1 may be made to have a heat distribution. Specifically, the temperature of the first rotation roll R1 in the region where the first belt-shaped mold S1 and the second belt-shaped mold S2 functioning as the lamination unit rotate along each other may be lower than the temperature of the first rotation roll R1 in the vicinity of the pressing roll R6 functioning as the first embossing unit. Likewise, the third rotation roll R3 may be made to have a heat distribution. Specifically, the temperature of the third rotation roll R3 in the region where the first belt-shaped mold S1 and the second belt-shaped mold S2 rotate along each other may be lower than the temperature of the second rotation roll R2 in the vicinity of the pressing roll R7 functioning as the second embossing unit. In this way, the temperature at the time of laminating the first embossed sheet A′ and the second embossed sheet B′ becomes lower than the temperature at the time of the embossing. Therefore, deformation of the surfaces of the embossed first embossed sheet A′ and second embossed sheet B′ can be further suppressed. As a result, the optical sheet 10 in which the deformation of the surface is further suppressed can be manufactured.

In addition, the resin sheets supplied to the first belt-shaped mold S1 and the second belt-shaped mold S2 may be preheated. In this case, a means that preheats the resin sheets before being supplied may be provided.

### Second Embodiment

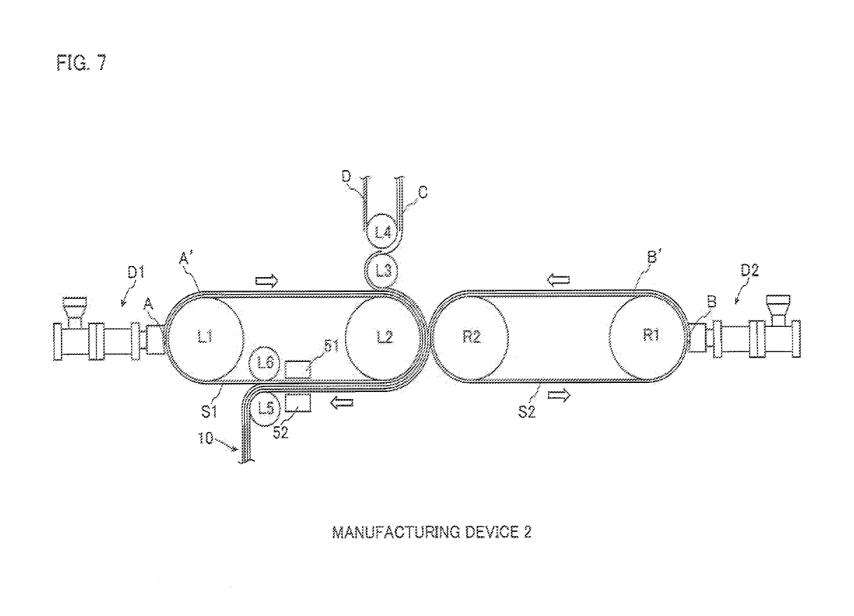

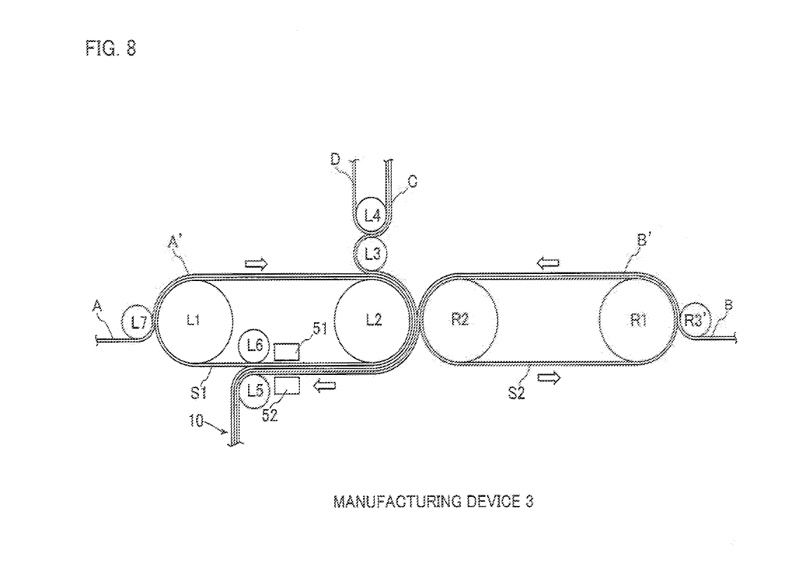

Next, a second embodiment of the present invention will be described in detail with reference to FIG. 7. An optical sheet that is manufactured in this embodiment is the same optical sheet as the optical sheet 10 that is manufactured in the first embodiment. Therefore, explanation of the optical sheet is omitted.

### [Manufacturing Device]

FIG. 7 is a diagram illustrating a manufacturing device 2 of the optical sheet according to the second embodiment of the present invention. As illustrated in FIG. 7, the manufacturing device 2 includes a left first rotation roll L1, a left second rotation roll L2, a first belt-shaped mold S1 hung on the left first rotation roll L1 and the left second rotation roll L2, a first extrusion die D1 supplying a first resin A while pressing the first resin A on the first belt-shaped mold S1 in a region where the first belt-shaped avoid S1 is hung on the left first rotation roll L1, a pressing roll L3 supplying an intermediate resin sheet C while pressing the intermediate resin sheet C on the first belt-shaped mold S1, a right first rotation roll R1, a right second rotation roll R2, a second belt-shaped mold S2 hung on the right first rotation roll R1 and the right second rotation roll R2, and a second extrusion die D2 supplying a second resin B while pressing the second resin B on the second belt-shaped mold S2 in a region where the second belt-shaped mold S2 is hung on the left first rotation roll R1 as a main configuration.

The left first rotation roll L1 and the left second rotation roll L2 have the same configuration as the first rotation roll R1 according to the first embodiment and the left first rotation roll L1 and the left second rotation roll L2 are heated together. However, because the temperature of the left second rotation roll L2 and the temperature of the left first rotation roll L1 are appropriately determined according to the kind of a resin supplied to the first belt-shaped mold S1, the temperatures thereof do not need to be equal to each other.

The belt-shaped mold S1 hung on the left first rotation roll L1 and the left second rotation roll L2 has the same configuration as the belt-shaped mold S1 according to the first embodiment and rotates around the left first rotation roll L1 and the left second rotation roll L2 by she rotation of the left first rotation roll L1 and the left second rotation roll L2.

The first extrusion die D1 is configured to extrude the first resin A of a softened state. The first extrusion die D1 is separated from an outer circumferential surface of the first belt-shaped mold S1 by an approximate thickness of the first optical layer 11 of the optical sheet 10 in a region where the first belt-shaped mold S1 is hung on the left first rotation roll L1 and is arranged at a position to supply the extruded first resin A to the first belt-shaped mold S1. That is, the first extrusion die D1 becomes a first supply unit that supplies a resin to tine first belt-shaped mold S1. As the first extrusion die D1, an extrusion die of a coat hanger type mounted to a uniaxial extruder is exemplified. In addition, a vacuum vent and a gear pump supply device can be used together according to a characteristic of the extruded first resin A. In addition, the first extrusion die D1 extrudes the first resin A of a state softened by the strong pressure, casts the first resin A to the first belt-shaped mold S1, and embosses the first resin A, thereby forming a first embossed sheet A′. For this reason, the first extrusion die D1 also becomes a first embossing unit that embosses the resin supplied to the first belt-shaped mold S1. That is, in this embodiment, the first extrusion die D1 functions as the first supply unit and the first embossing unit. In addition, it is preferable to set an interval of the first extrusion die D1 and the first belt-shaped mold S1 to about 0.05 to 1 mm to approach each other, from the viewpoint of preventing wrinkles or mixing of bubbles in the cast first resin A.

The pressing roll L3 has the same configuration as the pressing roll R8 according to the first embodiment. In addition, the pressing roll L3 is separated from an outer circumferential surface of the first belt-shaped mold S1 by about a thickness of the first optical layer 11 and the Intermediate optical layer 15 of the optical sheet 10 and is arranged on an upstream side of a rotation direction of the first belt-shaped mold S1 in a region where the first belt-shaped mold S1 is hung on the left second rotation roll L2. Specifically, the pressing roll L3 is arranged to enable to supply the hung intermediate optical sheet C to the first embossed sheet A′ with the intermediate optical sheet C sandwiched between the first embossed sheet A′ embossed on the first belt-shaped mold S1 and the pressing roll L3, when the intermediate optical sheet C becoming the intermediate optical layer 15 of the optical sheet 10 is hung. Therefore, the pressing roll R8 becomes an intermediate supply unit that supplies the intermediate optical sheet C to the first embossed sheet A′.

In addition, a process roll L4 is arranged at a position separated from the pressing roll L3, at the side of the pressing roll L3 opposite to the side of the first belt-shaped mold S1. The process roll L4 is configured to release a process a sheet D with sheets sandwiched between the pressing roll L3 and the process roll L4, when the sheet are supplied in a state in which the process sheet D is stuck on the intermediate optical sheet C.

The right first rotation roll R1 has the same configuration as the left first rotation roll L1, except that the right first rotation roll R1 rotates in a direction reverse to a rotation direction of the left first rotation roll L1. In addition, the right second rotation roll R2 has the same configuration as the left second rotation roll L2, except that the right second rotation roll R2 rotates in a direction reverse to a rotation direction of the left second rotation roll L2.

The second belt-shaped mold S2 hung on the right first rotation roll R1 and the right second rotation roll R2 has the same configuration as the first belt-shaped mold S1, except that a large number of molds for optical elements 12p formed in the second optical layer 12 of the optical sheet 10 are continuously formed on an outer circumferential surface side. In addition, the second belt-shaped mold S2 rotates around the right first rotation roll R1 and the right second rotation roll R2 by the rotation of the right first rotation roll R1 and the right second rotation roll R2.

The second extrusion die D2 is configured to extrude the second resin B of a softened state, similar to the first extrusion die D1. The second extrusion die D2 is separated from an outer circumferential surface of the second belt-shaped mold S2 by about a thickness of the second optical layer 12 of the optical sheet 10 in a region where the second belt-shaped mold S2 is hung on the right rotation roll R1 and is arranged at a position to supply the extruded second resin B to the second belt-shaped mold S2. That is, the second extrusion die D2 becomes a second supply unit that supplies a resin to the second belt-shaped mold S2. In addition, the second extrusion die D2 extrudes the second resin B of a state softened by the strong pressure, casts the second resin B to the second belt-shaped mold S2, and embosses the second resin B, thereby forming a second embossed sheet B′. For this reason, the second extrusion die D2 also becomes a second embossing unit that embosses the resin supplied to the second belt-shaped mold S2. That is, in this embodiment, the second extrusion die D2 functions as the second supply unit and the second embossing unit. In addition, it is preferable to set an interval of the second extrusion die D2 and the second belt-shaped mold S2 to about 0.05 to 1 mm to approach each other, from the viewpoint of preventing wrinkles or mixing of bubbles in the cast first resin A.

In addition, in this embodiment, as illustrated in FIG. 7, a system including the left first rotation roll L1, the left second rotation roll L2, the first belt-shaped mold S1, and the first extrusion die D1 and a system including the right second rotation roll R1, the right second rotation roll R2, the second belt-shaped mold S2, and the second extrusion die D2 are configured to be approximately bilaterally symmetric. In addition, a region of the first belt-shaped mold S1 hung on the left second rotation roll L2 and a region of the second belt-shaped mold S2 hung on the right second rotation roll R2 are separated from each other by a thickness of the approximate optical sheet 10 and face each other. In addition, because the first belt-shaped mold S1 and the second belt-shaped mold S2 rotate in directions reverse to each other, the first belt-shaped mold S1 and the second belt-shaped mold S2 move in the same direction, in a most approaching portion of the first belt-shaped mold S1 and the second belt-shaped mold S2.

As described above, the left second rotation roll L2 and the right second rotation roll R2 are heated. For this reason, when the resin sheets are arranged on the first rotation belt S1 and the second belt-shaped mold S2, respectively, the resin sheets receive heat from the first belt-shaped mold S1 and the second belt-shaped mold S2 and are sandwiched between the first belt-shaped mold S1 and the second belt-shaped mold S2 and are laminated, in the most approaching portion of the first belt-shaped mold S1 and the second belt-shaped mold S2. That is, a lamination unit is formed by a part of a region where the first belt-shaped mold S1 is hung on the left second rotation roll L2 and a part of a region where the second belt-shaped mold S2 is hung on the right second rotation roll R2.

In addition, in a place moved to a traveling direction of the first belt-shaped mold S1 from a facing portion of the first belt-shaped mold S1 and the second belt-shaped mold S2, cooling units 51 and 52 to cool the resin on the first belt-shaped mold S1 are arranged. The cooling unit 51 is arranged on an inner circumferential side of the first belt-shaped mold S1 and the cooling unit 52 is arranged on an outer circumferential side of the first belt-shaped mold S2. Because the resin on the first belt-shaped mold S1 cooled by the cooling units 51 and 52 is cured, the cooling units 51 and 52 become a curing unit.

In addition, in a place moved to the traveling direction of the first belt-shaped mold S1 from the cooling units 51 and 52, a set of releasing rolls L5 and L6 functioning as a releasing unit is arranged to sandwich the first belt-shaped mold S1 therebetween. Specifically, the releasing roll 15 is separated from the outer circumferential surface of the first belt-shaped mold S1 by the thickness of the optical sheet 10 and is arranged and the releasing roll L6 is provided to contact the inner circumferential surface of the first belt-shaped mold S1.

### [Manufacturing Method]

Next, a manufacturing method for the optical sheet by the manufacturing device 2 of the optical sheet will be described.

The manufacturing method for the optical sheet 10 by the manufacturing device 2 of the optical sheet according to this embodiment is different from the manufacturing method for the optical sheet according to the first embodiment in that the first releasing process P7 is performed before the curing process P6.

### <Device Operation Process P1>

First, the left first rotation roll L1, the left second rotation roll L2, the right first rotation roll R1, and tone right second rotation roll R2 illustrated in FIG. 7 are rotated. By the rotation of these rotation rolls, the first belt-shaped mold S1 rotates around the left first rotation roll L1 and the left second rotation roll L2 and the second belt-shaped mold S2 rotates around the right first rotation roll R1 and the right second rotation roll R2. As described above, the rotation directions of the first belt-shaped mold S1 and the second belt-shaped mold S2 are reverse to each other and the first belt-shaped mold S1 and the second belt-shaped mold S2 move in the same direction in the most approaching portion of the first belt-shaped mold S1 and the second belt-shaped mold S2. In addition, because a rotation speed of each of the belt-shaped molds is appropriately adjusted according to such as the thickness of each optical layer forming the optical sheet 10 to be manufactured or the kind of the resin, the rotation speed is not limited in particular. However, the rotation speed is preferably 1 to 30 m/min and is more preferably 2 to 20 m/min.

At this time, because the left first rotation roll L1, the left second rotation roll L2, the right first rotation roll R1, and the right second rotation roll R2 are heated, respectively, the region where the first belt-shaped mold S1 is hung on the left first rotation roll L1 and the left second rotation roll L2 is heated and the region where the second belt-shaped mold S2 is hung on the right first rotation roll R1 and the right second rotation roll R2 is heated. In this embodiment, the left second rotation roll L2 is preferably heated at the temperature lower than the temperature of the left first rotation roll L1. In addition, the right second rotation roll R2 is preferably heated at the temperature lower than the temperature of the right first rotation roll R1.

### [Resin Supply Process P2]

When the first belt-shaped mold S1 and the second belt-shaped mold S2 are rotated by the device operation process P1, the first resin A softened from the first extrusion die D1 is supplied to the first belt-shaped mold S1 and the second resin B softened from the second extrusion die D2 is supplied to the second belt-shaped mold S2. In this embodiment, because a supply place of the first resin A in the first belt-shaped mold S1 and a supply place of the second resin B in the second belt-shaped mold S2 are heated as described above, the first resin A and the second resin B are supplied directly to the heated places, respectively. The viscosity of the first resin A and the second resin B to be supplied is 50 to 10000 PaS and is preferably 300 to 3000 PaS.

### <Embossing Process P3>

The first resin A supplied to the first belt-shaped mold S1 is embossed on the first belt-shaped mold S1 by the pressing force from the first extrusion die D1 immediately after being supplied and the second resin B supplied to the second belt-shaped mold S2 is embossed on the second belt-shaped mold S2 by die pressing force from the second extrusion die D2 immediately after being supplied. The pleasing force of each of the first and second extrusion dies D1 and D2 depends on such as the kind or the viscosity of each of the resins forming the first resin A and the second resin B or the shape of each of the first belt-shaped mold S1 and the second belt-shaped mold S2 and is appropriately set. In this way, the first resin A embossed on the first belt-shaped mold S1 is moved as the first embossed sheet A′ by the rotation of the first belt-shaped mold S1 and the second resin B embossed on the second belt-shaped mold S2 is moved as the second embossed sheet B′ by the rotation of the second belt-shaped mold S2.

In this embodiment, the first resin A is supplied to the first belt-shaped mold S1 and is embossed and the second resin B is supplied to the second belt-shaped mold S2 and is embossed. That is, in this embodiment, the resin supply process P2 and the embossing process P3 are performed at the same time.

### <Intermediate Supply Process P4>

The intermediate optical sheet C in this embodiment has the same configuration as the intermediate optical sheet C according to the first embodiment. The intermediate optical sheet C is wound around a reel not illustrated, similar to the intermediate optical sheet C in the first embodiment. In addition, the intermediate optical sheet C in this embodiment is hung on the process roll L4 and is fed, similar to the first intermediate optical sheet C that is hung on the process roll R9 and is fed. In addition, only the intermediate optical sheet C in the supplied intermediate optical sheet C and process sheet D is hung on the pressing roll L3 and the process sheet D is released from the intermediate optical sheet C and is collected from the process roll L4. In addition, the intermediate optical sheet C is hung on the pressing roll L3 in a state in which the surface of the side of the third intermediate optical layer 15c faces the side of the pressing roll L3. The intermediate optical sheet C hung on the pressing roll L3 is sandwiched between the pressing roll L3 and the first embossed claret A′ moved together with the first belt-shaped mold S1 and is supplied to the first embossed sheet A′. At this time, because the second intermediate optical layer 15b functioning as an adhesive layer faces the side of the first embossed sheet A′, the intermediate optical sheet C is stuck on the first embossed sheet A′ and a deviation on the first embossed sheet A′ is prevented. In addition, similar to the first embodiment, the first embossed sheet A′ on the first belt-shaped mold S1 and the intermediate optical sheet C on the first embossed sheet are further moved by the rotation of the first belt-shaped mold S1.

### <Lamination Process P5>

A laminated body of the moved first embossed sheet A′ and intermediate optical sheet C and the second embossed sheet B′ approach each other as the first belt-shaped mold S1 and the second belt-shaped mold S2 approach each other. Then, the laminated body and the second embossed sheet B′ are sandwiched between the first belt-shaped mold S1 and the second belt-shaped mold S2 and are crimped to each other. In addition, the intermediate optical layer C and the second embossed sheet B′ are laminated integrally by the heat from the first belt-shaped mold S1 and the second belt-shaped mold S2. In this way, the first embossed sheet A′ and the second embossed sheet B′ are laminated integrally with the intermediate optical sheet C therebetween. At this time, as described above, when the left second rotation roll L2 is heated at the temperature lower than the temperature of the left first rotation roll L1 and the right second rotation roll R2 is heated at the temperature lower than the temperature of the right first rotation roll R1, the temperature at the time of laminating the first embossed sheet A′ and the second embossed sheet B′ becomes lower than the temperature at the time of embossing. Therefore, deformation of the surfaces of the first embossed sheet A′ and the second embossed sheet B′ that are embossed can be further suppressed. In addition, the pressures applied to the first embossed sheet A′ and the second embossed sheet B′ are preferably lower than the pressure applied to the resin on the first belt-shaped mold S1 in the first embossing unit and the pressure applied to the resin on the second belt-shaped mold S2 in the second embossing unit, from the viewpoint of further suppressing the deformation of the surfaces of the first embossed sheet A′ and the second embossed sheet B′. In this way, the optical sheet 10 in which the deformation of the surface is further suppressed can be manufactured.

### <First Releasing Process P7>

Immediately after the first embossed sheet A′, the intermediate embossed sheet C, and the second embossed sheet B′ are laminated, the second belt-shaped mold S2 loses touch with the first belt-shaped mold S1 and the second embossed sheet B′ is released from the second belt-shaped mold S2. In order to release the second embossed sheet B′ from the second belt-shaped mold S2, preferably, the temperature of the right second rotation roll R2 is lower than the temperature of the left second rotation roll L2 and the temperature of the second belt-shaped mold S2 is lower than the temperature of the first belt-shaped mold S1 in a facing portion of the first belt-shaped mold S1 and the second belt-shaped mold S2.

### <Curing Process P3>

When the second embossed sheet B′ is released from the second belt-shaped mold S2, in the laminated first embossed sheet A′, intermediate optical sheet C, and second embossed sheet B′, the temperate of the side of the second embossed sheet B′ begins to decrease gradually and curing begins to be performed from the side of the second embossed sheet B′. In addition, when the first belt-shaped mold S1 further moves, the first belt-shaped mold S1 is separated from the rotation roll R1 and accordingly, the temperature of the first belt-shaped mold S1 decreases. When the temperature of the first belt-shaped mold S1 decreases, the laminated first embossed sheet A′, intermediate optical sheet C, and second embossed sheet B′ are cooled from the side of the first embossed sheet A′ and are further cured from the side of the first embossed sheet A′. When the first belt-shaped mold S1 passes through a portion between the cooling units 51 and 52, the laminated first embossed sheet A′, intermediate optical sheet C, and second embossed sheet B′ are further cooled and are further cured. In this embodiment, the first belt-shaped mold S1 after losing touch with at least the first rotation roll R1 may be assumed as the curing unit.

### <Second Releasing Process P8>

Next, the laminated first embossed sheet A′, intermediate optical sheet C, and second embossed sheet B′ that move according to the rotation of the first belt-shaped mold S1 are sandwiched between the releasing roll L5 and the releasing roll L6 with the belt-shaped mold S1 therebetween. In addition, the laminated first embossed sheet A′, intermediate optical sheet C, and second embossed sheet B′ changes a direction to be wound around the releasing roll L5 and are released from the first belt-shaped mold S1. In this way, the optical sheet 10 in which the first embossed sheet A becomes the first optical layer 11, the second embossed sheet B becomes the second optical layer 12, and the intermediate optical sheet C becomes the intermediate optical layer 15 is obtained. In addition, the optical sheet 10 is wound around a reel not illustrated.

As described above, according to the manufacturing device 1 and the manufacturing method for the optical sheet 10 according to this embodiment, because the first and second resins A and B are supplied in a softened state and are embossed, the first and second resins A and B can be embossed in an optimal state by controlling the temperatures of the first and second resins A and B supplied by the first and second extrusion dies D1 and D2.

In addition, because the first and second extrusion dies D1 and D2 supply the first and second resins A and B in a softened stare, the setting temperatures of the left first rotation roll L1 and the right first rotation roll R1 can be decreased as compared with the case in which the resin is supplied without being softened as in the first embodiment and durability of the first and second belt-shaped shaped molds S1 and S2 can be improved. In addition, because the first and second resins A and B are supplied in a softened state, a processing speed can be increased and productivity can be improved.

In this embodiment, the pressing roll L3 may be heated or may not be heated. However, the pressing roll L3 is preferably heated at the temperature lower than the temperature of the left second rotation roll L2. In addition, the releasing rolls R10 and R11 are preferably cooled, from the viewpoint of more appropriately releasing the optical sheer 10 from the first belt-shaped molt S1.

In addition, in this embodiment, the first extrusion die D1 is configured to function as the first supply unit and the first embossing unit. However, the first supply unit and the first embossing unit may be separately provided. In this case, the pressing force of the first extrusion die D1 is weakened and a pressing roll having the save configuration as the pressing roll R6 according to the first embodiment is newly arranged on the downstream side of the first extrusion die D1 in the region where the first belt-shaped mold S1 is hung on the left first rotation roll L1, in close proximity to the first belt-shaped mold S1. In addition, the first resin A supplied to the first belt-shaped mold S1 may be sandwiched between the newly arranged pressing roll and the first belt-shaped mold and may be embossed on the first belt-shaped mold. In this case, the first extrusion die D1 becomes the first supply unit and the newly arranged pressing roll becomes the first embossing unit.

Likewise, the second extrusion die is configured to function as the second supply unit and the second embossing unit. However, the second supply unit and the second embossing unit may be separately provided. In this case, the pressing force of the second extrusion die D2 is weakened and a pressing roll having the same configuration as the pressing roll R7 according to the first embodiment is newly arranged on the downstream side of the second extrusion die D2 in the portion of the second belt-shaped mold S2 is hung on the right first rotation roll R1, in close proximity to the second belt-shaped mold S2. In addition, the second resin B supplied to the second belt-shaped mold S2 may be sandwiched between the newly arranged pressing roll and the second belt-shaped mold and may be embossed on the second belt-shaped mold. In this case, the second extrusion die D2 becomes the second supply unit and tune newly arranged pressing roll becomes the second embossing unit.

In addition, in the embodiment described above, a solution cast device such as a coater head may be provided, instead of the first extrusion die D1 and the second extrusion die D2. In this case, the resin supplied to the first belt-shaped mold S1 or the second belt-shaped mold S2 may be a resin solution or a resin dispersion solution. In addition, in this case, the supplied resin may be thickened to have a sheet shape by drying or ultraviolet curing, before embossing or lamination.

### Third Embodiment

Next, a third embodiment of the present invention will be described in detail with reference to FIG. 8. The same or equivalent components as the second embodiment are denoted with the same reference numerals and repetitive description is omitted. In this embodiment, a manufactured optical sheet is the same optical sheet as the optical sheet 10 that is manufactured in the first embodiment and is illustrated in FIG. 1.

### [Manufacturing Device]

FIG. 8 is a diagram illustrating a manufacturing device of the optical sheet according to the third embodiment of the present invention. As illustrated in FIG. 8, a manufacturing device 3 according to this embodiment is different from the manufacturing device 2 of the optical sheet according to the second embodiment in that, instead of the first extrusion die D1 according to the second embodiment, the same pressing roll L7 as the pressing roll R6 according to the first embodiment is provided at approximately the same position as the arrangement position of the first extrusion die D1 and, instead of the second extrusion die D2 according to the second embodiment, the same pressing roll R3 as the pressing roll L7 is arranged at approximately the same position as the arrangement position of the second extrusion die D2.

The pressing roll L7 has approximately the same configuration as the pressing roll R6 in the first embodiment. The pressing roll L7 is arranged to be separated from the outer circumferential surface of the first belt-shaped mold S1 by approximate the thickness of the first optical layer 11 of the optical sheet 10, in a region where the first belt-shaped mold S1 is hung on the left first rotation roll L1 and is heated. Specifically, the pressing roll L7 is arranged to enable to supply the hung first resin sheet A to the first belt-shaped mold S1 with the first resin sheet A sandwiched between the first belt-shaped mold S1 and the pressing roll L7, when the first resin sheet A becoming the first optical layer 11 of the optical sheet 10 is hung. For this reason, the pressing roll L7 becomes a first supply unit that supplies the resin to the first belt-shaped mold S1. In addition, the pressing roll L7 is heated and is arranged to press the first resin sheet A softened by heating of the first belt-shaped mold S1 by the left first rotation roll L1 and heating by the pressing roll L7 to the first belt-shaped mold S1 and emboss the first resin sheet A to form the first resin sheet A as a first embossed sheet A′ on the first belt-shaped mold S1. For this reason, the pressing roll L7 also becomes a first embossing unit that embosses the resin supplied to the first belt-shaped mould S1. That is, in this embodiment, the pressing roll L7 functions as the first supply unit and the first embossing unit.

In addition, a pressing roll R3′ has approximately the same configuration as the pressing roll L7. The pressing roll R3′ is arranged to be separated from the outer circumferential surface of the second belt-shaped mold S2 by approximate the thickness of the second optical layer 12 of the optical sheet 10, in a region where the second belt-shaped mold S2 is hung on the right first rotation roll R1 and is heated. Specifically, the pressing roll R3′ is arranged to enable to supply the hung second resin sheet B to the second belt-shaped mold S2 with the second resin sheet B sandwiched between the second belt-shaped mold S2 and the pressing roll R3′, when the second resin sheet B becoming the second optical layer 12 of the optical sheet 10 is hung. For this reason, the pressing roll R3′ becomes a second supply unit that supplies the resin to the second belt-shaped mold S2. In addition, the pressing roll R3′ is heated and is arranged to press the second resin sheet B softened by heating of the second belt-shaped mold S2 by the right first rotation roll R1 and heating by the pressing roll R3′ to the second belt-shaped mold S2 and emboss the second resin sheet B so form the second resin sheet B as a second embossed sheet B′ on the second belt-shaped mold S2. For this reason, the pressing roll R3′ also becomes a second embossing unit that embosses the resin supplied to the second belt-shaped mold S2. That is, in this embodiment, the pressing roll R3′ functions as the second supply unit and the second embossing unit.

### [Manufacturing Method]

A manufacturing method for the optical sheet 10 by the manufacturing device 3 of the optical sheet according to this embodiment is different from the manufacturing method for the optical sheet according to the second embodiment in that a sheet-shaped resin is supplied to the first belt-shaped mold S1 and the second belt-shaped mold S2 in a resin supply process.

First, a device operation process P is performed in the same way as the second embodiment and the first belt-shaped mold S1 and the second belt-shaped mold S2 are rotated while respective parts thereof are heated.

Next, a resin supply process P2 is performed. In this process according to this embodiment, the first resin sheet A that is fed from a reel not illustrated and is hung on the pressing roll L7 is sandwiched between the pressing roll L7 and the first belt-shaped mold S1 while being heated and is supplied to the first belt-shaped mold S1. In this embodiment, the first resin sheet A is supplied directly to a heated portion of the first belt-shaped mold S1.

In addition, the second resin sheet B that is fed from a reel not illustrated and is hung on the pressing roll R3′ is sandwiched between the pressing roll R3′ and the second belt-shaped mold S2 while being heated and is supplied to the second belt-shaped mold S2. In this embodiment, the second resin sheet B is supplied directly to a heated portion of the second belt-shaped mold S2.

Because the first and second resin sheets A and B are pressed by the pressing rolls L7 and R3′ and are supplied to the first and second belt-shaped molds S1 and S2, occurrence of wrinkles or mixing of bubbles in the first and second resin sheets A and B is suppressed.

In this way, the resin is supplied to each of the first belt-shaped mold S1 rotating in a circumferential direction and the second belt-shaped mold S2 rotating in the circumferential direction.

Next, an embossing process is performed. The first resin sheet A supplied to the first belt-shaped mold S1 is heated at the temperature equal to or more than the flow start temperature of the first resin sheet A by heat of the first belt-shaped mold S1 immediately after being supplied and is softened. The viscosity of the softened first resin sheet A may be the same as the viscosity of the first resin sheet A softened in the first embodiment. In addition, the softened first resin sheet A is embossed on the first belt-shaped mold S1 by the pressing force from the pressing roll L7. In addition, the pressing force of the pressing roll L7 may be the same as the pressing force of the pressing roll R6 according to the first embodiment. In this way, the first resin sheet A embossed on the first belt-shaped mold S1 is moved as a first embossed sheet A′ by the rotation of the first belt-shaped mold S1.

In this embodiment the first resin sheet A is supplied to the first belt-shaped mold S1 and is embossed and the second resin sheet B is supplied to the second belt-shaped mold S2 and is embossed. That is, in this embodiment, the resin supply process P2 and the embossing process P3 are performed at the same time.

In addition, the second resin sheet B supplied to the second belt-shaped mold S2 is heated at the temperature equal to or more than the flow start temperature of the second resin sheet B by heat of the second belt-shaped mold S2 immediately after being supplied and is softened. The viscosity of the softened second resin sheet B may be the same as the viscosity of the second resin sheet B softened in the first embodiment. In addition, the softened second resin sheet B is embossed on the second belt-shaped mold S2 by the pressing force from the pressing roll R3′. In addition, the pressing force of the pressing roll R3′ may be the same as the pressing force of one pressing roll R7 according to the first embodiment. In this way, the second resin sheet B embossed on the second belt-shaped mold S2 is moved as a second embossed sheet B′ by the rotation of the second belt-shaped mold S2.

In addition, similar to the second embodiment, the intermediate supply process P4 to the second releasing process P8 are performed to obtain the optical sheet 10.

The present invention has been described on the basis of the first to third embodiments. however, the present invention is not limited thereto.

For example, at least one surface of the intermediate optical layer 15 of the optical sheet 10 illustrated in FIG. 1 may have adhesiveness at a normal temperature. In this case, at least one of the second intermediate optical layer 15b and the third intermediate optical layer 15c of the optical sheet 10 illustrated in FIG. 1 may be made of a material having the adhesiveness at the normal temperature. When only one surface of the intermediate optical layer 15 has the adhesiveness at the normal temperature, the process sheet D may be stuck on the surface of the intermediate optical layer C having the adhesiveness and the process sheet D may be released in the same way as the above-described embodiment. In addition, when both surfaces of the intermediate optical layer 15 have the adhesiveness at the normal temperature, in each embodiment, the intermediate optical sheet in which the process sheets are stuck on both surfaces is supplied, the process sheet stuck on the adhesive layer adhered to the first embossed sheet A′ is released, and the intermediate optical sheet is supplied to the first embossed sheet A′, similar to the supply of the intermediate optical sheet C according to each embodiment. Then, the other process sheet may be released. In this case, because the intermediate optical sheet and the second embossed sheet B′ are adhered by the adhesive layer, lamination by thermal crimp is not necessary. Therefore, in the second and third embodiments, the left second rotation roll L2 or the right second rotation roll R2 may not be heated.

In addition, at least one of the second intermediate optical layer 15b and the third intermediate optical layer 15c in the intermediate optical layer 15 of the optical steel 10 may be omitted.

In addition, in the embodiments described above, the intermediate optical sheet C is supplied to the first embossed sheet A′. However, the present invention is not limited thereto and the intermediate optical sheer C may be supplied to the second embossed sheet B′. When the first embossed sheet A′ and the second embossed sheer B′ are laminated, the intermediate optical sheet C may be supplied directly between the first embossed sheet A′ and the second embossed sheet B′.

In addition, in the embodiments described above, the optical sheet 10 having the intermediate optical layer 15 illustrated in FIG. 1 is manufactured. However, the present invention is not limited thereto and may be used even when an optical sheet in which the intermediate optical layer 15 is not provided and the first optical layer 11 and the second optical layer 12 are laminated directly is manufactured. In this case, the intermediate supply unit of the manufacturing device of the optical sheet becomes unnecessary and the intermediate supply process of the manufacturing method for the optical device becomes unnecessary. Therefore, the pressing roll R8 and tire process roll R9 in the first embodiment become unnecessary and the pressing roll L3 and the process roll L4 in the second and third embodiments become unnecessary.

In addition, the present invention can be used even when an optical sheet having the plurality of intermediate optical layers 15 is manufactured. In this case, the plurality of intermediate supply units of the manufacturing device of the optical sheet may be arranged and the intermediate supply process of the manufacturing method for the optical device may be performed several times.

In addition, in the embodiments described above, the resins supplied to the first belt-shaped mold S1 and the second belt-shaped mold S2 are thermoplastic resins and the resins softened by heating are embossed on the first belt-shaped mold and the second belt-shaped mold. In addition, the laminated product of the first embossed sheet A′ and the second embossed sheet B′ is cooled and cured. However, the present invention is not limited thereto and the resins supplied to the first belt-shaped mold S1 and the second belt-shaped mold S2 may be other resins such as ultraviolet curable resins. In this case, a means that irradiates ultraviolet rays onto the supplied resins and curing the resins may be provided.

### Industrial Applicability

As described above, according to the present invention, an optical-sheet manufacturing device and an optical-sheet manufacturing method that make it possible to suppress surface deformation and improve productivity are provided and are used effectively for manufacturing a reflection sheet, a light guide sheet, a light diffusion sheet, a hologram sheet, and other optical sheet.

### Reference Signs List

1, 2, 3 . . . optical-sheet manufacturing device
10 . . . optical sheet
11 . . . first optical layer
11p, 12p . . . optical element
12 . . . second optical layer
15 . . . intermediate optical layer
15a . . . first intermediate optical layer
15b . . . second intermediate optical layer
15c . . . third intermediate optical layer
51, 52 . . . cooling unit
60 . . . hollow particle
61 . . . shell
62 . . . space
63 . . . void
65, 65A, 65B . . . binding resin
A . . . first resin (sheet)
A′ . . . first embossed sheet
B . . . second resin (sheet)
B′ second embossed sheet
C . . . intermediate optical sheet
D1 . . . first extrusion die
D2 . . . second extrusion die
L1, L2 . . . rotation roll
L3 . . . pressing roll
L4 . . . process roll
L5, L6 . . . releasing roll
L7 . . . pressing roll
P1 . . . device operation process
P2 . . . resin supply process
P3 . . . embossing process
P4 . . . intermediate supply process
P5 . . . lamination process
P6 . . . curing process
P7 . . . first releasing process
P8 . . . second releasing process
R1 to R5 . . . rotation roll
R3′, R6 to R8 . . . pressing roll
R9 . . . process roll
R10, R11 . . . releasing roll
S1 . . . first belt-shaped mold
S2 . . . second belt-shaped mold

1. An optical-sheet manufacturing device for manufacturing an optical sheet having at least two optical layers, comprising:
a first belt-shaped mold and a second belt-shaped mold that rotate in a circumferential direction;
a first supply unit that supplies a resin to the first belt-shaped mold;
a first embossing unit that embosses the resin supplied to the first belt-shaped mold on the first belt-shaped mold to form a first embossed sheet becoming an optical layer of the side of one surface of the optical sheet;
a second supply unit that supplies a resin to the second belt-shaped mold;
a second embossing unit that embosses the resin supplied to the second belt-shaped mold on the second belt-shaped mold to form a second embossed sheet becoming an optical layer of the side of the other surface of the optical sheet; and
a lamination unit that sandwiches the first embossed sheet and the second embossed sheet between the first belt-shaped mold and the second belt-shaped mold and laminates the first embossed sheet and the second embossed sheet,
wherein the first embossed sheet embossed on the first belt-shaped mold and the second embossed sheet embossed on the second belt-shaped mold are moved to the lamination unit by rotation of the first belt-shaped mold and the second belt-shaped mold and are laminated.

2. The optical-sheet manufacturing device according to claim 1, further comprising:
an intermediate supply unit that supplies an intermediate optical sheet becoming an intermediate optical layer between the optical layer of the side of one surface and the optical layer of the side of the other surface in the optical sheet to at least one of the first embossed sheet and the second embossed sheet,
wherein, in the lamination unit, the first embossed sheet and the second embossed sheet are laminated with the intermediate optical sheet therebetween.

3. The optical-sheet manufacturing device according to claim 2,
wherein the intermediate optical sheet includes a fine particle layer in which fine particles having an average particle diameter of 5 nm to 300 nm are used as main components.

4. The optical-sheet manufacturing device according to claim 3,
wherein the fine particles are ceramic particles.

5. The optical-sheet manufacturing device according to claim 4,
wherein the fine particle layer does not have a binder to bind the ceramic particles, and
the ceramic particles adjacent to each other contact each other.

6. The optical-sheet manufacturing device according to claim 4,
wherein the fine particle layer includes the ceramic particles, a binding resin to bind surface portions of the ceramic particles, and voids formed between the ceramic particles.

7. The optical-sheet manufacturing device according to claim 6,
wherein a glass transition point of the binding resin is lower than a glass transition point of the resin configuring the first embossed sheet and a glass transition point of the resin configuring the second embossed sheet.

8. The optical-sheet manufacturing device according to claim 2,
wherein the intermediate optical sheet includes a resin layer made of a resin, and
a glass transition point of the resin configuring the resin layer is lower than a glass transition point of the resin configuring the first embossed sheet and a glass transition point of the resin configuring the second embossed sheet.

9. The optical-sheet manufacturing device according to claim 8,
wherein viscosity of the resin configuring the resin layer in the lamination unit is 150000 PaS or less.

10. The optical-sheet manufacturing device according to claim 1,
wherein temperatures of the first embossed sheet and the second embossed sheet in the lamination unit are lower than a temperature of the resin embossed in the first embossing unit and a temperature of the resin embossed in the second embossing unit.

11. The optical-sheet manufacturing device according to claim 1,
wherein the first belt-shaped mold is hung on a first heating roll and is heated on the first heating roll and the second belt-shaped mold is hung on a second heating roll and is heated on the second heating roll,
in the first embossing unit, the resin supplied from the first supply unit to the first belt-shaped mold on the first heating roll is pressed by a heated first pressing roll,
in the second embossing unit, the resin supplied from the second supply unit to the second belt-shaped mold on the second heating roll is pressed by a heated second pressing roll, and
in the lamination unit, the first embossed sheet on the first belt-shaped mold on the first heating roll and the second embossed sheet on the second belt-shaped mold on the second heating roll are pressed to each other.

12. The optical-sheet manufacturing device according to claim 11,
wherein a temperature of the first heating roll is lower than a temperature of the first pressing roll and a temperature of the second heating roll is lower than a temperature of the second pressing roll.

13. The optical-sheet manufacturing device according to claim 1,
wherein pressures applied to the first embossed sheet and the second embossed sheet in the lamination unit are lower than a pressure applied to the resin on the first belt-shaped mold in the first embossing unit and a pressure applied to the resin on the second belt-shaped mold in the second embossing unit.

14. The optical-sheet manufacturing device according to claim 1,
wherein the first embossing unit functions as the first supply unit and the second embossing unit functions as the second supply unit.

15. The optical-sheet manufacturing device according to claim 1, further comprising:
a curing unit that cures the first embossed sheet and the second embossed sheet after the first embossed sheet and the second embossed sheet are laminated.

16. An optical-sheet manufacturing method for manufacturing an optical sheet having at least two optical layers, comprising:
a resin supply process for supplying a resin to each of a first belt-shaped mold rotating in a circumferential direction and a second belt-shaped mold rotating in the circumferential direction;
an embossing process for embossing the resin supplied to the first belt-shaped mold on the first belt-shaped mold to form a first embossed sheet becoming an optical layer of the side of one surface of the optical sheet and embossing the resin supplied to the second belt-shaped mold on the second belt-shaped mold to form a second embossed sheet becoming an optical layer of the side of the other surface of the optical sheet; and
a lamination process for sandwiching the first embossed sheet and the second embossed sheet between the first belt-shaped mold and the second belt-shaped mold and laminating the first embossed sheet and the second embossed sheet, after the first embossed sheet and the second embossed sheet are moved by the rotation of the first belt-shaped mold and the second belt-shaped mold.

17. The optical-sheet manufacturing method according to claim 16, further comprising:
an intermediate supply process for supplying an intermediate optical sheet becoming an intermediate optical layer between the optical layer of the side of one surface and the optical layer of the side of the other surface in the optical sheet to at least one of the first embossed sheet and the second embossed sheet,
wherein, in the lamination process, the first embossed sheet and the second embossed sheet are laminated with the intermediate optical sheet therebetween.

18. The optical-sheet manufacturing method according to claim 17,
wherein the intermediate optical sheet includes a fine particle layer in which fine particles having an average particle diameter of 5 nm to 300 nm are used as main components.

19. The optical-sheet manufacturing method according to claim 18,
wherein the fine particles are ceramic particles.

20. The optical-sheet manufacturing method according to claim 19,
wherein the fine particle layer does not have a binder to bind the ceramic particles, and
the ceramic particles adjacent to each other contact each other.

21. The optical-sheet manufacturing method according to claim 19,
wherein the fine particle layer includes the ceramic particles, a binding resin to bind surface portions of the ceramic particles, and voids formed between the ceramic particles.

22. The optical-sheet manufacturing method according to claim 21,
wherein a glass transition point of the binding resin is lower than a glass transition point of the resin configuring the first embossed sheet and a glass transition point of the resin configuring the second embossed sheet.

23. The optical-sheet manufacturing method according to claim 17,
wherein the intermediate optical sheet includes a resin layer made of a resin, and
a glass transition point of the resin configuring the resin layer is lower than a glass transition point of the resin configuring the first embossed sheet and a glass transition point of the resin configuring the second embossed sheet.

24. The optical-sheet manufacturing method according to claim 23,
wherein viscosity of the resin configuring the resin layer in the lamination process is 150000 PaS or less.

25. The optical-sheet manufacturing method according to claim 16,
wherein temperatures of the first embossed sheet and the second embossed sheet in the lamination process are lower than temperatures of the resin of the first belt-shaped mold and the resin of the second belt-shaped mold embossed in the embossing process.

26. The optical-sheet manufacturing method according to claim 16,
wherein pressures applied to the first embossed sheet and the second embossed sheet in the lamination process are lower than a pressure applied to the resin on the first belt-shaped mold and a pressure applied to the resin on the second belt-shaped mold in the embossing process.

27. The optical-sheet manufacturing method according to claim 16,
wherein the supply process and the embossing process are performed at the same time.

28. The optical-sheet manufacturing method according to claim 16, further comprising:
a curing process for curing the first embossed sheet and the second embossed sheet after the lamination process.
